(19) United States
(12) Patent Application Publication
(10) Pub. No.: US 2024/0004037 A1
(43) Pub. Date: Jan. 4, 2024

(54) DISTANCE MEASURING DEVICE AND SOLID-STATE IMAGING DEVICE

(71) Applicant: Panasonic Intellectual Property Management Co., Ltd., Osaka (JP)

(72) Inventors: Yuki SUGIURA, OSAKA FU (JP); Akito INOUE, OSAKA FU (JP); Shigeru SAITOU, KYOTO FU (JP); Shinzo KOYAMA, OSAKA FU (JP)

(21) Appl. No.: 18/466,458

(22) Filed: Sep. 13, 2023

Related U.S. Application Data
(63) Continuation of application No. PCT/JP2022/014268, filed on Mar. 25, 2022.

(30) Foreign Application Priority Data
Mar. 31, 2021 (JP) 2021-061570

(51) Int. Cl. G01S 7/481; G01S 7/484; G01S 17/10

(52) U.S. Cl. CPC G01S 7/4816; G01S 7/484; G01S 17/10

(57) ABSTRACT

A distance measuring device includes: a light emitting unit; a pixel array including a plurality of pixels arranged in a matrix; and a control unit calculating the distance to a measuring target. Each of the plurality of pixels includes: an avalanche photodiode; a primary accumulation region for temporarily holding a signal charge; and a plurality of memory elements provided in parallel with respect to the primary accumulation region. The control unit performs a plurality of times of light exposure at timings corresponding to different distance sections within one pulse period of outgoing light from the light emitting unit, allows signal charges generated after the respective times of light exposure to be accumulated in the different memory elements, and reads out the signal charges to calculate the distance to the measuring target.

### CROSS-REFERENCE TO RELATED APPLICATIONS

This is a continuation of International Application No. PCT/JP2022/014268 filed on Mar. 25, 2022, which claims priority to Japanese Patent Application No. 2021-061570 filed on Mar. 31, 2021. The entire disclosures of these applications are incorporated by reference herein.

### BACKGROUND

The present disclosure relates to a distance measuring device configured to be able to acquire distance information, and a solid-state imaging device.

Solid-state imaging devices have conventionally been focused on taking an image with high sensitivity and high precision. In recent years, a solid-state imaging device having an additional function of acquiring distance information has appeared. With distance information added to an image, three-dimensional information of an imaging target can be acquired.

For example, when the imaging target is a person, gestures of the person can be detected three-dimensionally. Such a solid-state imaging device can therefore be used as an input device of various types of equipment. Also, by being mounted in an automobile, the solid-state imaging device can recognize the distances to objects and persons present in the neighborhood of the automobile, and therefore is applicable to fields such as collision prevention and automatic driving.

As a distance measuring method, a time of flight (TOF) method is known, for example, in which light is radiated to an imaging target and the distance to this target is measured based on the return time of reflected wave from the target.

International Patent Publication No. WO2007/026779A1 describes a phase difference TOF type semiconductor distance measuring element using a photodiode, in which two transfer gate electrodes are provided for one photodiode and each of the transfer gate electrodes is connected to a memory element. In this patent document, signal charges generated by the photodiode are individually read out, and the distance to a target is measured from the distribution ratio of the accumulated charges.

The TOF method however has a problem that as the measuring target is farther, the number of return photons is smaller, and therefore the ratio of light contributing to a signal with respect to the outgoing light, i.e., the light use efficiency decreases. In a configuration having a plurality of transfer transistors for a photodiode, like the one in the cited patent document, light exposure for a plurality of distance sections can be made with one time of outgoing light, whereby the light use efficiency can be improved. However, this configuration, using the photodiode, is required to perform complete transfer of charges. This causes placement restriction, raising a problem that a desired number of transistors cannot be placed. There is also a problem that as the number of transfer transistors is larger, the potential design becomes more complicated. That is, there is a problem that, with low expandability, the light use efficiency of the distance measuring device cannot be sufficiently enhanced.

An objective of the present disclosure is enhancing the light use efficiency of the distance measuring device.

### SUMMARY

In one mode of the present disclosure, a distance measuring device includes: a light emitting unit emitting outgoing light toward a measuring target; a pixel array including a plurality of pixels arranged in a matrix and receiving reflected light of the outgoing light reflected from the measuring target as incident light; and a control unit controlling the light emitting unit and the pixel array and calculating a distance to the measuring target, wherein each of the plurality of pixels includes an avalanche photodiode photoelectrically converting the incident light to generate a signal charge, a primary accumulation region temporarily holding the signal charge; and a plurality of memory elements provided in parallel with respect to the primary accumulation region for accumulating the signal charge, and the control unit controls the light emitting unit to emit the outgoing light as pulses of a predetermined period, performs a plurality of times of light exposure at timings corresponding to different distance sections within one pulse period of the outgoing light, allows signal charges generated after the respective times of light exposure to be accumulated in the different memory elements, and reads out the signal charges to calculate the distance to the measuring target.

According to the present disclosure, the light use efficiency of the distance measuring device can be enhanced.

### BRIEF DESCRIPTION OF THE DRAWINGS

FIG. 1 is a schematic view showing a configuration example of a distance measuring device.

FIG. 2 is a circuit diagram of a pixel according to the first embodiment.

FIG. 3 is a view showing an operation sequence of the pixel according to the first embodiment.

FIG. 4 is a circuit diagram of a pixel according to Alteration 1 of the first embodiment.

FIG. 5 is a circuit diagram of a pixel according to Alteration 2 of the first embodiment.

FIG. 6 is a view showing an operation sequence of a first transistor and a fourth transistor according to Alteration 2 of the first embodiment.

FIG. 7 is a circuit diagram of a solid-state imaging device according to the second embodiment.

FIG. 8 is a view showing part of an operation sequence of a first transistor in FIG. 7.

FIG. 9 is a circuit diagram of the solid-state imaging device according to the second embodiment.

FIG. 10 is a circuit diagram of a solid-state imaging device according to the second embodiment.

FIG. 11 is a circuit diagram of a pixel according to the third embodiment.

FIG. 12 is a view showing an operation sequence of the pixel according to the third embodiment.

FIG. 13 is a circuit diagram of a pixel according to Alteration 1 of the third embodiment.

FIG. 14 is a view showing an operation sequence of the pixel according to Alteration 1 of the third embodiment.

FIG. 15 is a circuit diagram of a pixel according to the fourth embodiment.

FIG. 16 is a view showing an operation sequence of the pixel according to the fourth embodiment.

FIG. 17 is a circuit diagram of a pixel according to Alteration 1 of the fourth embodiment.

FIG. 18 is a view showing an operation sequence of the pixel according to Alteration 1 of the fourth embodiment.

FIG. 19 is a circuit diagram of a pixel according to Alteration 2 of the fourth embodiment.

FIG. 20 is a circuit diagram of a pixel in which memory elements are expanded in the row and column directions.

FIG. 21 is a circuit diagram of another solid-state imaging device.

FIG. 22 is a circuit diagram of a solid-state imaging device according to the second embodiment.

FIG. 23 is a circuit diagram showing another example of the solid-state imaging device of FIG. 11.

### DETAILED DESCRIPTION

Embodiments of the present disclosure will be described hereinafter with reference to the accompanying drawings. It is to be noted that the following description of the embodiments is essentially mere illustration and by no means intended to limit the present invention, applications thereof, or uses thereof.

### First Embodiment

—Configuration of Distance Measuring Device—

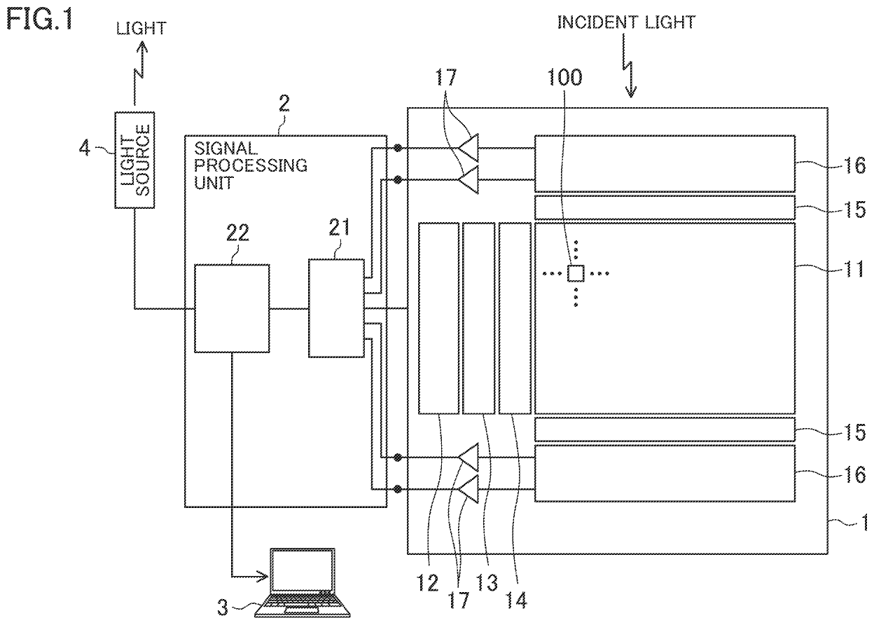

FIG. 1 is a schematic view showing a configuration example of a distance measuring device according to the first embodiment. As shown in FIG. 1, the distance measuring device of this embodiment includes a solid-state imaging device 1, a signal processing unit 2, a computing machine 3, and a light source 4.

The light source 4 emits outgoing light toward a measuring target. Pulsed light having a predetermined period is output from the light source 4. The period and width of the pulsed light are controlled with a logic memory 22 to be described later. The light source 4 is an example of the light emitting unit. Note that the light source 4 may be configured to emit outgoing light toward a specific measuring target, or may be configured to illuminate the entire of a region of which three-dimensional information is desired (measuring target) with light. That is, the light source 4 may be equipped with a mechanism that diffuses light to illuminate the entire of a region of which three-dimensional information is desired with light.

The solid-state imaging device 1 includes a pixel array 11, a vertical shift register 12, a multiplexer 13, a driver circuit 14, column circuits 15, horizontal shift registers 16, and output amplifiers 17.

In the pixel array 11, a plurality of pixels 100 are arranged in a matrix and receive, as incident light, light reflected from a measuring target present in a measuring region to which the outgoing light has been emitted from the light source 4. Each of the pixels 100 is exposed to light according to a voltage applied from the multiplexer 13 or the driver circuit 14. Also, each pixel 100 outputs a voltage signal indicating the exposed result according to a selection signal received from the multiplexer 13. Configuration examples of the pixel array 11 and the pixels 100 will be described later.

The vertical shift register 12 transfers voltage signals output from the pixels 100 to vertical signal lines 18 in the column direction, i.e., into the column circuits 15. The vertical shift register 12 selects a specific row of pixels 100 in the pixel array 11, whereby the voltage signals indicating the exposure results are output from the pixels 100 sequentially row by row in the pixel array 11. The vertical shift register 12 outputs an address signal indicating the selected row of the pixel array 11 to the multiplexer 13.

The multiplexer 13 supplies voltages to the pixels 100 based on the address signal received from the vertical shift register 12.

The driver circuit 14 supplies voltages for light exposure of the pixels 100 in the pixel array 11 to the pixels 100. Configuration examples of the driver circuit 14 will be described later.

The column circuits 15 receive the voltage signals transferred from the vertical shift register 12, perform processing such as correlated double sampling (CDS) of removing an offset component different among the pixels 100, and output the results to the horizontal shift registers 16.

The horizontal shift registers 16 sequentially transfer the signals output from the column circuits 15 to the output amplifiers 17.

The output amplifiers 17 amplify the signals sequentially received from the horizontal shift registers 16 and output the results to the signal processing unit 2.

The signal processing unit 2 includes an analog front end 21 and the logic memory 22.

The analog front end 21 converts the analog signals output from the output amplifiers 17 of the solid-state imaging device 1 to digital signals, and outputs the resultant digital signals to the logic memory 22. Note that the analog front end 21 may change the order of signals output from the output amplifiers 17 if required. The signal processing unit 2 is an example of the control unit.

The logic memory 22 generates distance signals based on the signals received from the analog front end 21. The generated distance signals are output to the computing machine 3.

The computing machine 3, which is a computer, for example, generates three-dimensional information of the surroundings of the solid-state imaging device 1 based on the distance signals received from the logic memory 22. Note that the signal processing unit 2 may generate three-dimensional information of the surroundings of the solid-state imaging device 1 based on the distance signals.

—Configuration of Pixel—

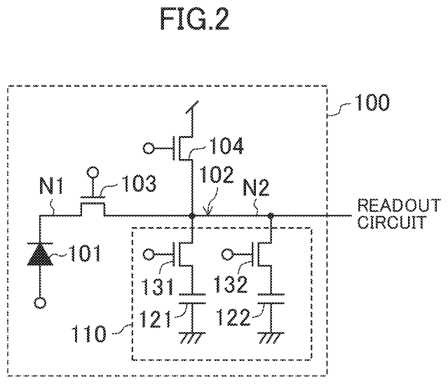

As shown in FIG. 2, the pixel 100 includes an avalanche photodiode 101, a primary accumulation region 102, a first transistor 103, a memory unit 110, and a third transistor 104.

The avalanche photodiode 101 photoelectrically converts incident light to generate a signal charge. Also, the avalanche photodiode 101 has a function of increasing the charge amount of the signal charge.

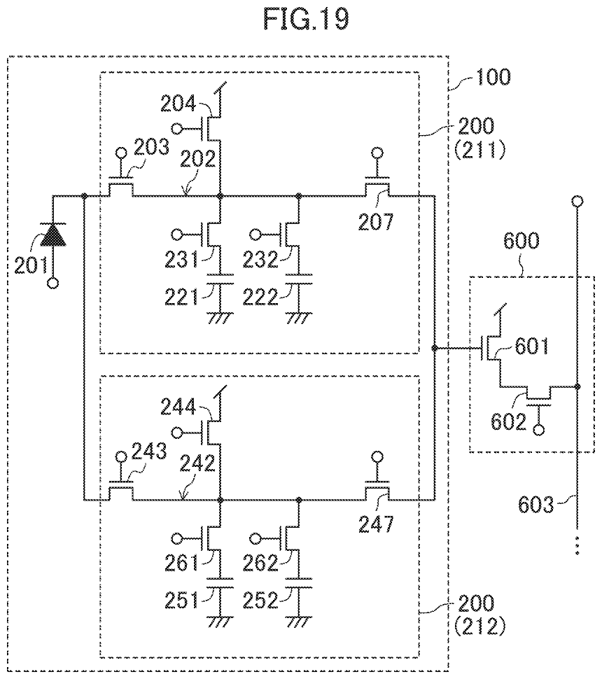

The primary accumulation region 102 has a function of temporarily holding the signal charge generated by the avalanche photodiode 101. The configuration of the primary accumulation region 102 is not especially limited, but only required to be able to temporarily hold the signal charge. In FIG. 2, as the primary accumulation region 102, an example of temporarily holding the signal charge at a node N2 is shown. The node N2 is connected to a readout circuit. The configuration of the readout circuit is not especially limited, but, for example, is a circuit connected to a signal line via a source follower circuit 600 (see FIG. 19) to be described later. This also holds true for any readout circuit to follow.

The first transistor 103 is provided between the cathode of the avalanche photodiode 101 and the primary accumulation region 102. The gate of the first transistor 103 is connected to a bias circuit to be described later, for example, and turned ON/OFF based on a control signal output from the bias circuit. That is, the first transistor 103 has a function as a switch enabling/disabling transfer of the signal charge from the avalanche photodiode 101 to the primary accumulation region 102. In the following description, the node connecting the avalanche photodiode 101 and the first transistor 103 is referred to as a node N1.

The memory unit 110 includes a plurality of memory elements 120 and a plurality of second transistors 130. The plurality of memory elements 120 are provided in parallel with respect to the node N2 (primary accumulation region 102). Each of the second transistors 130 is provided between each of the memory elements 120 and the node N2. The second transistor 130, operating based on a control signal received at its gate, has a function as a switch enabling/disabling transfer of the signal charge from the node N2 to the corresponding memory element 120. More specifically, when the second transistor 130 is turned ON, allowing conduction between the node N2 and the memory element 120 connected to this second transistor 130, the signal charge at the node N2 is accumulated in the memory element 12.

FIG. 2 shows an example in which the memory unit 110 is constituted by two memory elements 120 (121 and 122) and two second transistors 130 (131 and 132). More specifically, a serial circuit of the second transistor 131 and the memory element 121 and a serial circuit of the second transistor 132 and the memory element 122 are connected in parallel between the node N2 and the ground. Note that the number of the memory elements 120 and the number of the second transistors 130 are not limited to two, but may be three or more.

The third transistor 104, connected to the primary accumulation region 102, has a function of discharging the signal charge in the primary accumulation region 102. In FIG. 2, the third transistor 104 is provided between the power supply VD and the node N2. The gate of the third transistor 104 is connected to a bias circuit to be described later, for example. When the third transistor 104 is turned ON based on a control signal output from the bias circuit, allowing conduction between the power supply VD and the node N2, the signal charge at the node N2 (in the primary accumulation region 102) is discharged due to the action of the power supply VD.

—Operation of Solid-State Imaging Device—

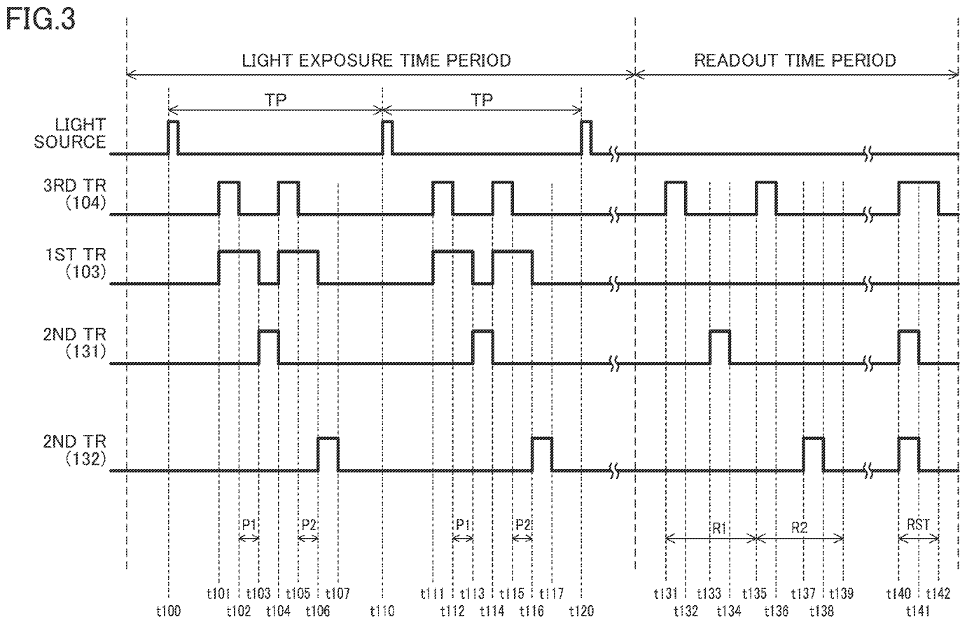

FIG. 3 shows an operation sequence of the pixel 100 during the time of light exposure processing and readout processing performed by the solid-state imaging device 1. As shown in FIG. 3, in the solid-state imaging device 1, a plurality of times of light exposure are performed by turning ON/OFF the first transistor 103 a plurality of times at timings corresponding to different distance sections. After the respective times of light exposure, the plurality of second transistors 130 are turned ON/OFF to accumulate the exposure results in the respective memory elements 120. Thereafter, during the readout time period, the signal charges stored in the memory elements 120 are read out to calculate the distance to the measuring target.

<Light Exposure Processing>

First, the operation of the solid-state imaging device during the light exposure time period according to this embodiment will be described with reference to FIG. 3. During the light exposure time period, assume that pulsed outgoing light is emitted from the light source 4 at a predetermined pulse period TP repeatedly (e.g., 1000 pulses). In FIG. 3, the time from t100 to t110 and the time from t110 to t120 are each one pulse period TP. The pulse period TP is set longer than the time of flight of light corresponding to the maximum value of the range of the measurement distance. For example, when the maximum value of the range of the measurement distance is 250 [m], the time when light travels 500 [m] as a round trip is about 1.67 [psec], and therefore the pulse period TP is set at a value greater than this time.

As described above, within one pulse period of the outgoing light, a plurality of times of light exposure are executed at timings corresponding to different distance sections. FIG. 3 shows an example in which two times of light exposure are performed within one pulse period TP and the two-time light exposure is performed repeatedly.

To state more specifically, at time t101, the third transistor 104 and the first transistor 103 are turned ON simultaneously, to discharge the signal charges at the node N1 and the node N2. With this, the potential on the cathode side of the avalanche photodiode 101 is reset.

At time t102, at which the third transistor 104 is turned OFF, the first-time light exposure is started. Specifically, a signal charge generated by the avalanche photodiode 101 is input into the primary accumulation region 102 via the first transistor 103. At time t103, at which the first transistor 103 is turned OFF, the first-time light exposure is completed, and the signal charge is temporarily held in the primary accumulation region 102. In the first-time light exposure, reflected light from a measuring target present in a first distance section D1 corresponding to the lapse time from time t100 at which the light source 4 emitted light until a time period P1 is input into the pixel 100 as incident light.

After the first transistor 103 is turned OFF at time t103, the second transistor 131 is turned ON. With this, the signal charge held in the primary accumulation region 102, i.e., the result of the first-time light exposure is accumulated in the memory element 121 until the second transistor 131 is turned OFF at time t104.

At time t104, after the second transistor 131 is turned OFF, the third transistor 104 and the first transistor 103 are simultaneously turned ON, to reset the potential on the cathode side of the avalanche photodiode 101.

At time t105, at which the third transistor 104 is turned OFF, the second-time light exposure is started. Specifically, a signal charge generated by the avalanche photodiode 101 is input into the primary accumulation region 102 via the first transistor 103. At time t106, at which the first transistor 103 is turned OFF, the second-time light exposure is completed, and the signal charge is temporarily held in the primary accumulation region 102. In the second-time light exposure, reflected light from a measuring target present in a second distance section D2 corresponding to the lapse time from time t100 at which the light source 4 emitted light until a time period P2 is input into the pixel 100 as incident light.

After the first transistor 103 is turned OFF at time t106, the second transistor 132 different from the transistor used in the first-time light exposure is turned ON. With this, the signal charge held in the primary accumulation region 102, i.e., the result of the second-time light exposure is accumulated in the memory element 122.

As a result, the first-time light exposure result is stored in the first memory element 121 and the second-time light exposure result is stored in the second memory element 122.

The operation in one pulse period TP described above, as one set, is repeated a predetermined number of times (e.g., 1000 pulses), whereby signals in the distance sections D1 and D2 are accumulated in the memory elements 121 and 122, respectively. For example, in FIG. 3, in the next pulse period TP (time t110 to t120), the first-time light exposure is performed during the time period P1 of t112 to t113 and the second-time light exposure is performed during the time period P2 of t115 to t116. Like the case of the preceding pulse period TP, in the first-time light exposure, reflected light from a measuring target present in the first distance section D1 corresponding to the lapse time until the time period P1 is accumulated in the memory element 121. In the second-time light exposure, reflected light from a measuring target present in the second distance section D2 corresponding to the lapse time until the time period P2 is accumulated in the memory element 122. Thereafter, similar processing is repeated a predetermined number of times.

While FIG. 3 shows the example in which the second transistor 131 is turned ON immediately after the first transistor 103 is turned OFF, the operation is not limited to this. For example, the second transistor 131 may be turned ON some time after the first transistor 103 is turned OFF. By shortening the time from turning OFF of the first transistor 103 until turning ON of the second transistor 131, however, the number of times of light exposure can be increased, i.e., the light use efficiency of the distance measuring device can be enhanced. This also holds true for the relationship between the first transistor 103 and the second transistor 132.

<Readout Processing>

When the light exposure processing by a predetermined number of pulses is finished, readout processing is then executed. The operation of the solid-state imaging device 1 during the readout time period will be described hereafter with reference to FIG. 3. First, during a first-time readout time period R1 (t131 to t135), readout processing for the first distance section D1 is executed.

Specifically, at time t131, the third transistor 104 is turned ON, to discharge the signal charge in the primary accumulation region 102. With this, the primary accumulation region 102 is reset.

At time t132, the third transistor 104 is turned OFF, and when the second transistor 131 is turned ON at time t133, the signal charge accumulated in the memory element 121 corresponding to the first distance section D1 is read out to the primary accumulation region 102. The read signal charge is then read out to the subsequent readout circuit, and the distance to the measuring target present in the first distance section D1 is calculated in the signal processing unit 2.

At time t134, the second transistor 131 is turned OFF, and at time t135, the third transistor 104 is turned ON again, to reset the primary accumulation region 102.

At time t136, the third transistor 104 is turned OFF, and when the second transistor 132 is turned ON at time t137, the signal charge accumulated in the memory element 122 corresponding to the second distance section D2 is read out to the primary accumulation region 102. The read signal charge is then read out to the subsequent readout circuit, and the distance to the measuring target present in the second distance section D2 is calculated in the signal processing unit 2.

Once the readout processing for all the distance sections (the first and second distance sections D1 and D2 in this example) is finished, reset processing for the memory unit 110 is executed. Specifically, the third transistor 104 and all the second transistors 130 (the second transistors 131 and 132 in this example) are simultaneously turned ON, to discharge the signal charges accumulated in all the memory elements 120 (the memory elements 121 and 122 in this example) (see time t140 to t141 in FIG. 3). Thereafter, the second transistors 131 and 132 are turned OFF, to discharge the charge remaining in the primary accumulation region 102 (see time t141 to t142 in FIG. 3).

As described above, the distance measuring device of this embodiment includes: the light source 4 that emits outgoing light toward a measuring target; the pixel array 11 that includes a plurality of pixels 100 arranged in a matrix and receives reflected light of the outgoing light reflected from the measuring target as incident light; and the control unit that controls the light source 4 and the pixel array 11 and calculates the distance to the measuring target. Each of the plurality of pixels 100 includes: the avalanche photodiode 101 that photoelectrically converts incident light to generate a signal charge; the primary accumulation region 102 for temporarily holding the signal charge; the first transistor 103 provided between the output of the avalanche photodiode 101 and the primary accumulation region 102 for enabling/disabling transfer of the signal charge to the primary accumulation region 102; a plurality of memory elements 120 provided in parallel with respect to the primary accumulation region 102 for accumulating signal charges; a plurality of second transistors 130 provided between the primary accumulation region 102 and the corresponding memory elements 120 for enabling/disabling transfer of the signal charges to the memory elements 120; and the third transistor 104 connected to the primary accumulation region 102 for discharging the signal charge in the primary accumulation region 102.

With the configuration described above, it is possible to increase the number of times of light exposure for each pulse period TP and, as a result, increase the number of times of multiplication. Since the light use efficiency can be determined by “light use efficiency=number of times of multiplication/number of times of light emission,” for example, the light use efficiency of the distance measuring device can be enhanced in comparison with the case of exposing light once for each pulse period TP.

—Alteration 1—

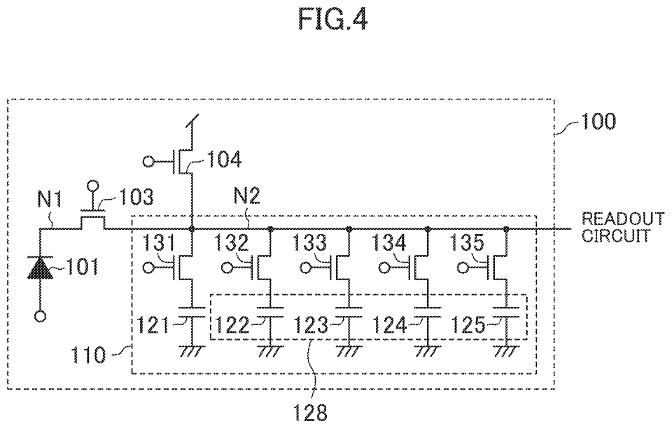

FIG. 4 shows a circuit diagram of a pixel according to Alteration 1 of the first embodiment.

Alteration 1 shows an example in which the memory unit 110 is constituted by five memory elements 120 (121 to 125) and five second transistors 130 (131 to 135). The plurality of memory elements 120 constituting the memory unit 110 include at least one first memory element smaller in memory capacity than the primary accumulation region. The first memory element is a one-count only memory element, for example. In the example of FIG. 4, the memory elements 122 to 125 enclosed in a dashed-line box 128 are smaller in memory capacity than the primary accumulation region 102. That is, the memory elements 122 to 125 are first memory elements.

The memory element 121 is configured to have a memory capacity permitting a plurality of counts, for example. With this, while the memory elements 122 to 125 are dedicated to one count, the memory element 121 can be used to respond to the case of relatively near distance sections and the case where background light is relatively great.

As described above, by using at least one memory element 120 as the one-count only first memory element, the S/N ratio is improved, whereby the readout efficiency can be improved. Such a configuration having the first memory element can be suitably used in an environment where the number of return photons is relatively small such as one where background light is poor and the distance is long.

Note that some of the memory elements 120 may be the first memory elements as shown in FIG. 4, or all of the memory elements 120 may be the first memory elements. Also, a plurality of first memory elements may additionally serve as a single memory capacity permitting more than one count. Specifically, by operating a plurality of first memory elements simultaneously, their memory capacities can be handled as a single memory capacity.

—Alteration 2—

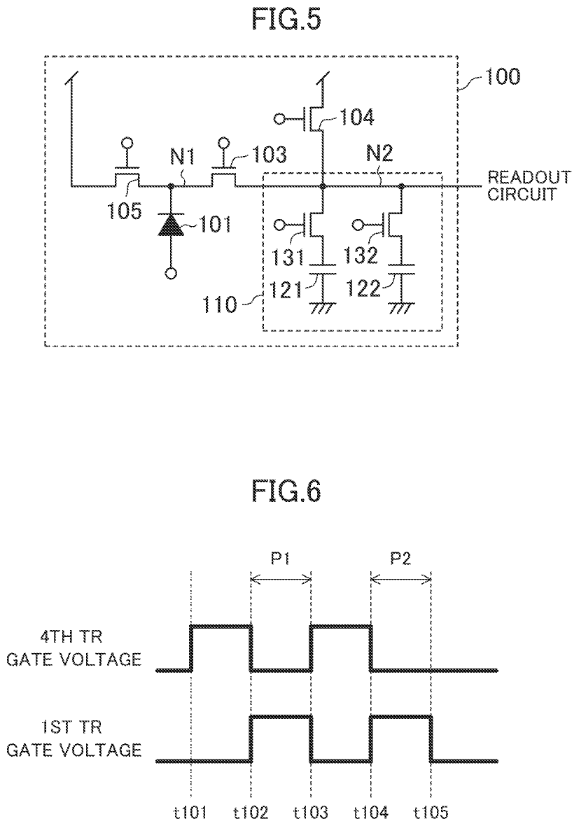

FIG. 5 shows a circuit diagram of a pixel according to Alteration 2 of the first embodiment.

Alteration 2 is different from the first embodiment in having a fourth transistor 105 connected to the node N1, to which the cathode of the avalanche photodiode 101 is connected, to initialize the node N1 to a fixed potential. The node N1 is an example of a first node. The other configuration is similar to that of the first embodiment described above, and therefore detailed description thereof is omitted here.

FIG. 6 shows an operation sequence of the first transistor 103 and the fourth transistor 105 according to Alteration 2. Note that the times indicated in FIG. 6 correspond to those in FIG. 3 described above.

In the above-described first embodiment, the cathode of the avalanche photodiode 101 is reset by turning ON the first transistor 103 and the third transistor 104 simultaneously. By contrast, in FIG. 6, the cathode of the avalanche photodiode 101 is reset by turning ON the fourth transistor 105 at time t101 until time t102. The other operation is similar to that in FIG. 3, and therefore detailed description thereof is omitted here.

Having the above configuration, transistors required to perform high-speed ON/OFF operation can be centralized. More specifically, with the placement of the fourth transistor 105, the reset of the cathode of the avalanche photodiode 101 can be centralized in the fourth transistor 105. This eliminates the necessity for the first transistor 103 and the third transistor 104 to perform high-speed ON/OFF operation. A large-capacity capacitance element must be placed outside the pixel 100 to operate a transistor at high speed. By centralizing transistors required to perform high-speed ON/OFF operation, therefore, increase in chip area can be prevented or reduced. Also, since the ON resistance is small in comparison with the case of reset via two transistors, the discharge rate of charges, i.e., the reset rate can be made faster.

### Second Embodiment

In this embodiment, a solid-state imaging device 1 including the driver circuit 14 that drives the pixel 100 described in the first embodiment will be described.

The driver circuit 14 includes a first driver circuit 141 for turning ON/OFF the first transistor 103 and a second driver circuit 142 for turning ON/OFF the third transistor 104.

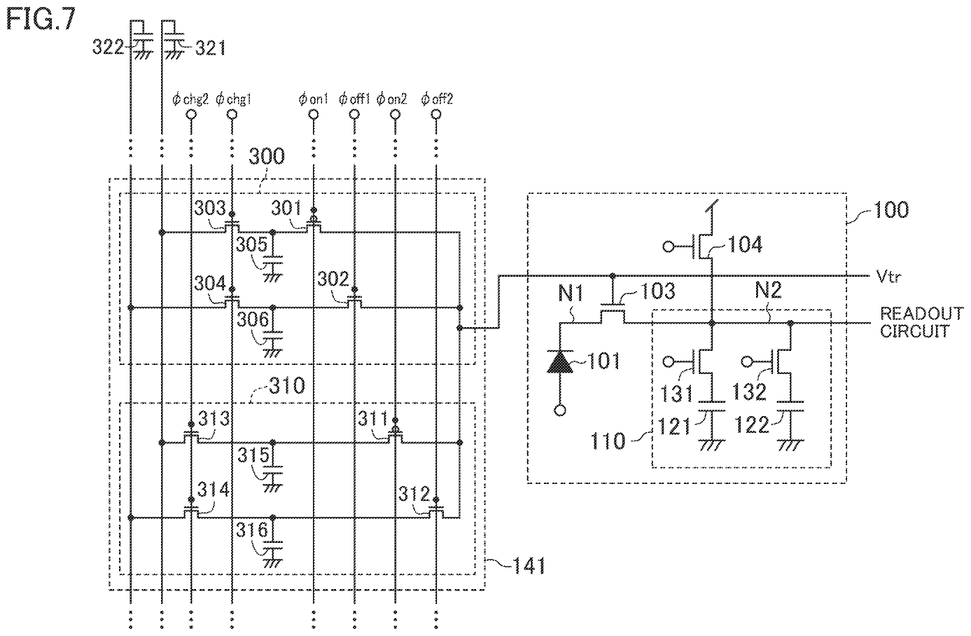

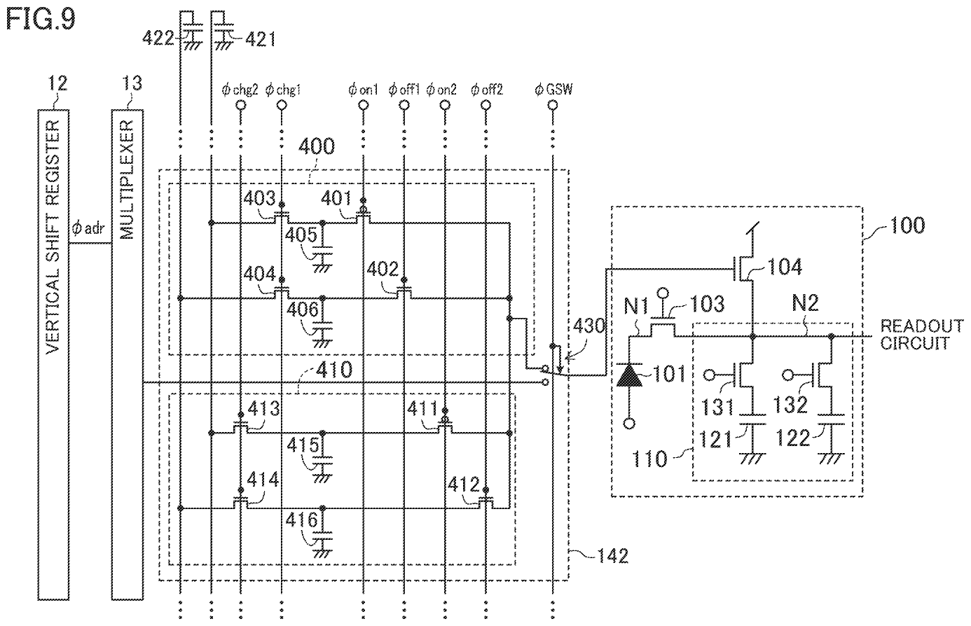

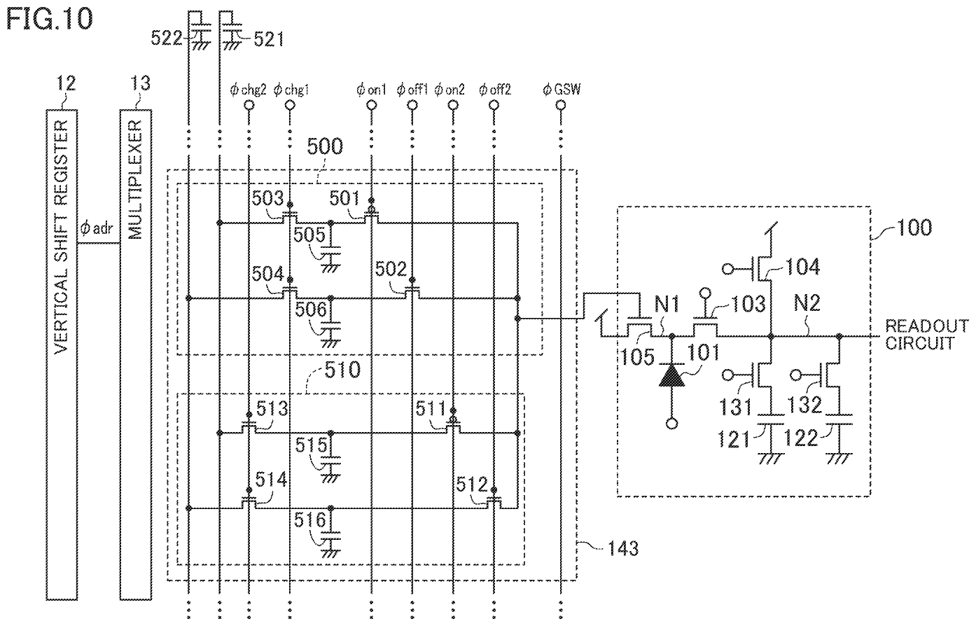

FIGS. 7 and 9 show circuit diagrams of the solid-state imaging device 1 according to this embodiment. Note that, in FIG. 7, the configurations of components other than the first driver circuit 141 are omitted as appropriate for easy description of the configuration of the first driver circuit 141. This also holds true for FIG. 9 and FIG. 10 to be described later.

—First Driver Circuit—

As shown in FIG. 7, the first driver circuit 141 includes the number of first bias circuits 300 and 310 corresponding with the number of memory elements 121 and 122 (two in this example). The first driver circuit 141 gives a gate voltage Vtr to the gate of the first transistor 103 thereby turning ON/OFF the first transistor 103.

The first bias circuit 300 includes a first capacitance 305 connected to the gate of the first transistor 103 via a first switching element 301 and a second capacitance 306 connected to the gate of the first transistor 103 via a second switching element 302. The first capacitance 305 is connected to a capacitor 321 for charge supply via a transistor 303. The second capacitance 306 is connected to a capacitor 322 for charge supply via a transistor 304. A first ON signal ϕon1 is given to the gate of the first switching element 301, and a first OFF signal ϕoff1 is given to the gate of the second switching element 302. A first charge signal ϕchg1 is given to the gates of the transistors 303 and 304. The first capacitance 305 and the second capacitance 306 are examples of a bias supply element.

The first bias circuit 310 includes a first capacitance 315 connected to the gate of the first transistor 103 via a first switching element 311 and a second capacitance 316 connected to the gate of the first transistor 103 via a second switching element 312. The first capacitance 315 is connected to the capacitor 321 for charge supply via a transistor 313. The second capacitance 316 is connected to the capacitor 322 for charge supply via a transistor 314. A second ON signal ϕon2 is given to the gate of the first switching element 311, and a second OFF signal ϕoff2 is given to the gate of the second switching element 312. A second charge signal ϕchg2 is given to the gates of the transistors 313 and 314. The first capacitance 315 and the second capacitance 316 are examples of the bias supply element.

The configuration of the pixel 100 is the same as that in FIG. 2 (the first embodiment), and therefore detailed description thereof is omitted here.

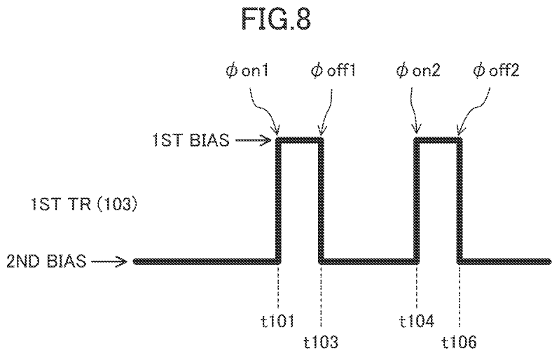

FIG. 8 shows part of the operation sequence of the first transistor 103 during the time from t100 to t110, taken from the operation sequence of FIG. 3. In FIG. 8, the transistors 303, 304, 313, and 314 are turned ON previously with the first charge signal ϕchg1 and the second charge signal ϕchg2, whereby the first capacitances 305 and 315 are charged to a predetermined first bias and the second capacitances 306 and 316 are charged to a predetermined second bias. The first bias is a bias for turning ON the first transistor 103, and the second bias is a bias for turning OFF the first transistor 103, for example.

At time t101, the first switching element 301 is turned ON with the first ON signal ϕon1, to allow the first bias to be given from the first capacitance 305 to the gate of the first transistor 103. At this time, the first switching element 311 and the second switching elements 302 and 312 are OFF. Thus, the first transistor 103 is turned ON.

At time t103, the second switching element 302 is turned ON with the first OFF signal ϕoff1, to allow the second bias to be given from the second capacitance 306 to the gate of the first transistor 103. At this time, the first switching elements 301 and 311 and the second switching element 312 are OFF. Thus, the first transistor 103 is turned OFF.

At time t104, the first switching element 311 is turned ON with the second ON signal ϕon2, to allow the first bias to be given from the first capacitance 315 to the gate of the first transistor 103. At this time, the first switching element 301 and the second switching elements 302 and 312 are OFF. Thus, the first transistor 103 is turned ON.

At time t106, the second switching element 312 is turned ON with the second OFF signal ϕoff2, to allow the second bias to be given from the second capacitance 316 to the gate of the first transistor 103. At this time, the first switching elements 301 and 311 and the second switching element 302 are OFF. Thus, the first transistor 103 is turned OFF.

As described above, by providing the number of first bias circuits 300 and 310 matching with the number of memory elements 121 and 122, high-speed operation of the first transistor 103 can be achieved.

—Second Driver Circuit—

As shown in FIG. 9, the second driver circuit 142 includes the number of second bias circuits 400 and 410 corresponding with the number of memory elements 121 and 122 (two in this example). The second driver circuit 142 gives a gate voltage to the gate of the third transistor 104 thereby turning ON/OFF the third transistor 104.

The second bias circuit 400 includes a third capacitance 405 connected to the gate of the third transistor 104 via a third switching element 401 and a fourth capacitance 406 connected to the gate of the third transistor 104 via a fourth switching element 402. The third capacitance 405 is connected to a capacitor 421 for charge supply via a transistor 403. The fourth capacitance 406 is connected to a capacitor 422 for charge supply via a transistor 404. The first ON signal ϕon1 is given to the gate of the third switching element 401, and the first OFF signal ϕoff1 is given to the gate of the fourth switching element 402. The first charge signal ϕchg1 is given to the gates of the transistors 403 and 404.

The second bias circuit 410 includes a third capacitance 415 connected to the gate of the third transistor 104 via a third switching element 411 and a fourth capacitance 416 connected to the gate of the third transistor 104 via a fourth switching element 412. The third capacitance 415 is connected to the capacitor 421 for charge supply via a transistor 413. The fourth capacitance 416 is connected to the capacitor 422 for charge supply via a transistor 414. The second ON signal ϕon2 is given to the gate of the third switching element 411, and the second OFF signal ϕoff2 is given to the gate of the fourth switching element 412. The second charge signal ϕchg2 is given to the gates of the transistors 413 and 414.

In addition, the second driver circuit 142 includes a switching element 430 provided between the second bias circuits 400 and 410 and the third transistor 104. During light exposure processing, the switching element 430 is switched to a position where the third switching elements 401 and 411 and the fourth switching elements 402 and 412 are connected to the gate of the third transistor 104. During readout processing, the switching element 430 is switched to a position where the output of the multiplexer 13 is connected to the gate of the third transistor 104.

The configuration of the pixel 100 is the same as that in FIG. 2 (the first embodiment), and therefore detailed description thereof is omitted here. Also, since the second driver circuit 142 operates substantially similarly to the first driver circuit 141, description of the operation thereof is omitted here.

As described above, by providing the number of second bias circuits 400 and 410 matching with the number of memory elements 121 and 122, high-speed operation of the third transistor 104 can be achieved.

Note that, when the fourth transistor 105 is provided as described above with reference to FIG. 5, the driver circuit 14 may be provided with a third driver circuit 143 for turning ON/OFF the fourth transistor 105 in place of the second driver circuit 142.

—Third Driver Circuit—

As shown in FIG. 10, the third driver circuit 143 includes the number of third bias circuits 500 and 510 corresponding with the number of memory elements 121 and 122 (two in this example). The third driver circuit 143 gives a gate voltage to the gate of the fourth transistor 105 thereby turning ON/OFF the fourth transistor 105.

The third bias circuit 500 includes a fifth capacitance 505 connected to the gate of the fourth transistor 105 via a fifth switching element 501 and a sixth capacitance 506 connected to the gate of the fourth transistor 105 via a sixth switching element 502. The fifth capacitance 505 is connected to a capacitor 521 for charge supply via a transistor 503. The sixth capacitance 506 is connected to a capacitor 522 for charge supply via a transistor 504. The first ON signal ϕon1 is given to the gate of the fifth switching element 501, and the first OFF signal ϕoff1 is given to the gate of the sixth switching element 502. The first charge signal ϕchg1 is given to the gates of the transistors 503 and 504.

The third bias circuit 510 includes a fifth capacitance 515 connected to the gate of the fourth transistor 105 via a fifth switching element 511 and a sixth capacitance 516 connected to the gate of the fourth transistor 105 via a sixth switching element 512. The fifth capacitance 515 is connected to the capacitor 521 for charge supply via a transistor 513. The sixth capacitance 516 is connected to the capacitor 522 for charge supply via a transistor 514. The second ON signal ϕon2 is given to the gate of the fifth switching element 511, and the second OFF signal ϕoff2 is given to the gate of the sixth switching element 512. The second charge signal ϕchg2 is given to the gates of the transistors 513 and 514.

The configuration of the pixel 100 is the same as that in FIG. 5 (Alteration 2 of the first embodiment), and therefore detailed description thereof is omitted here. Also, since the operation of the third driver circuit 143 is substantially the same as that of the first driver circuit 141 although the transistor to drive is different, description thereof is omitted here.

Note that a fourth driver circuit 144 for turning ON/OFF the second transistors 130 (131 and 132) may be provided.

—Fourth Driver Circuit—

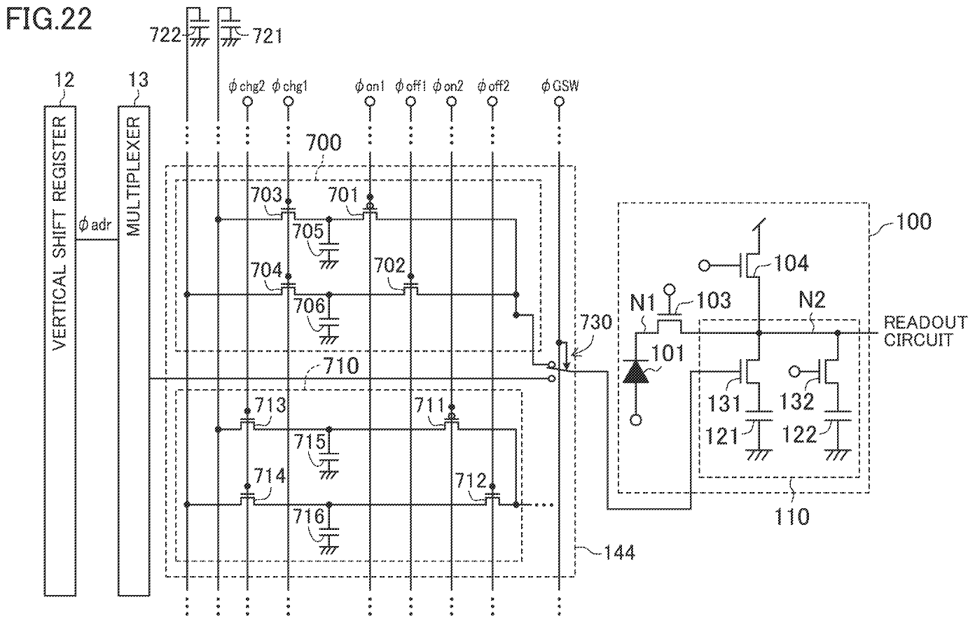

As shown in FIG. 22, the fourth driver circuit 144 includes the number of fourth bias circuits 700 and 710 corresponding to the number of memory elements 121 and 122 (two in this example).

By providing the number of fourth bias circuits 700 and 710 matching with the number of memory elements 121 and 122, high-speed operation of the second transistors 130 (131 and 132) can be achieved.

In FIG. 22, the fourth bias circuit 700 gives a gate voltage to the gate of the second transistor 131 thereby turning ON/OFF the second transistor 131.

More specifically, the fourth bias circuit 700 includes a seventh capacitance 705 connected to the gate of the second transistor 131 via a seventh switching element 701 and an eighth capacitance 706 connected to the gate of the second transistor 131 via an eighth switching element 702. The seventh capacitance 705 is connected to a capacitor 721 for charge supply via a transistor 703. The eighth capacitance 706 is connected to a capacitor 722 for charge supply via a transistor 704. The first ON signal ϕon1 is given to the gate of the seventh switching element 701, and the first OFF signal ϕoff1 is given to the gate of the eighth switching element 702. The first charge signal ϕchg1 is given to the gates of the transistors 703 and 704.

In addition, the fourth driver circuit 144 includes a switching element 730 provided between the fourth bias circuit 700 and the second transistor 131. During light exposure processing, the switching element 730 is switched to a position where the seventh switching element 701 and the eighth switching element 702 are connected to the gate of the second transistor 131. During readout processing, the switching element 730 is switched to a position where the output of the multiplexer 13 is connected to the gate of the second transistor 131.

Although not specifically illustrated in FIG. 22, the fourth bias circuit 710 is connected to the gate of the second transistor 132 via a switching element similar to the switching element 730. The connection configuration between the fourth bias circuit 710 and the second transistor 132 is similar to the connection configuration between the fourth bias circuit 700 and the second transistor 131. Detailed description thereof is therefore omitted here. Also, since the configuration of the pixel 100 is the same as that in FIG. 2 (the first embodiment), detailed description thereof is omitted here. Furthermore, since the fourth driver circuit 144 operates substantially similarly to the second driver circuit 142, description of the operation thereof is omitted here.

As described above, by providing the number of fourth bias circuits 700 and 710 matching with the number of memory elements 121 and 122, high-speed operation of the second transistors 131 and 132 can be achieved.

As described above, the solid-state imaging device 1 of this embodiment includes: the light source 4 that emits outgoing light toward a measuring target; the pixel array 11 that includes a plurality of pixels 100 arranged in a matrix and receives incident light; and the signal processing unit 2 that controls the light source 4 and the pixel array 11 and calculates the distance to the measuring target. Each of the plurality of pixels 100 includes: the avalanche photodiode 101 that photoelectrically converts incident light to generate a signal charge; the primary accumulation region 102 for temporarily holding the signal charge; the first transistor provided between the cathode of the avalanche photodiode 101 and the primary accumulation region 102 for enabling/disabling transfer of the signal charge to the primary accumulation region 102; and a plurality of memory elements 120 provided in parallel with respect to the primary accumulation region 102 for accumulating signal charges. The signal processing unit 2, receiving gate voltages from the different bias supply elements 305, 306, 315, and 316 of the first driver circuit 141 at different timings within one period, switches the first transistor 103 between ON and OFF, thereby performing a plurality of times of light exposure and allowing the resultant signal charges to be accumulated in the different memory elements 121 and 122.

With the configuration described above, it is possible to increase the number of times of light exposure for each pulse period TP and, as a result, increase the number of times of multiplication. Since the light use efficiency can be determined by “light use efficiency=number of times of multiplication/number of times of light emission,” for example, the light use efficiency of the solid-state imaging device can be enhanced in comparison with the case of exposing light once for each pulse period TP.

Moreover, since the first transistor 103 can be switched between ON and OFF at high speed within the limited time of the light pulse period, the light use efficiency of the solid-state imaging device can be further enhanced.

### Another Configuration Example of Solid-State Imaging Device

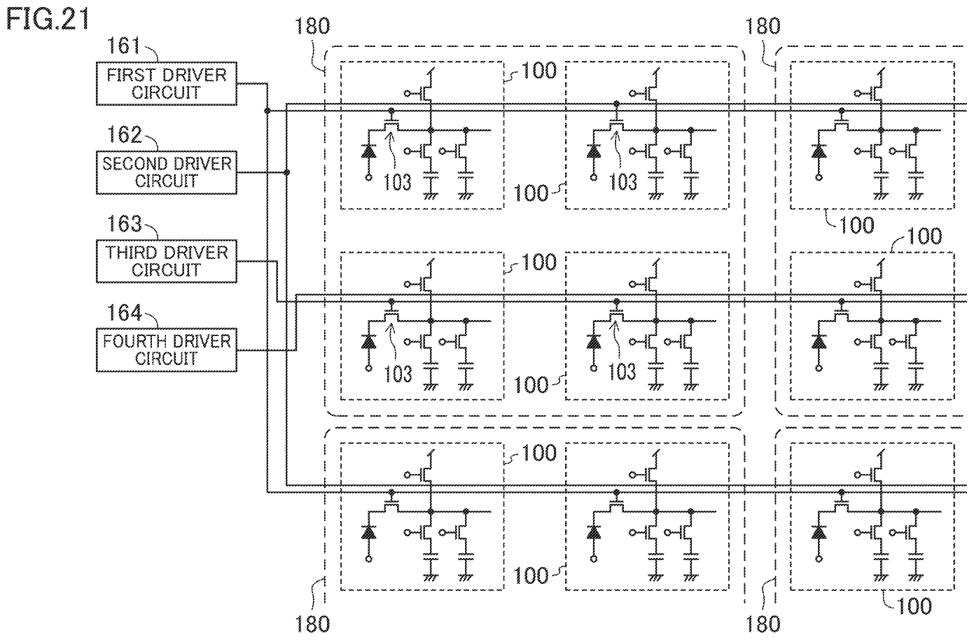

FIG. 21 shows another configuration example of the solid-state imaging device.

In FIG. 21, the pixel array 11 is constituted by pixel units 180, each having four pixels 100, arranged in a matrix. Each of the pixel units 180 includes a first pixel 100 in the upper left part, a second pixel 100 in the upper right part, a third pixel 100 in the lower left part, and a fourth pixel 100 in the lower right part as viewed in the figure.

In each of the pixel units 180, the output of a first driver 161 is connected to the gate of the first transistor 103 of the first pixel 100. Likewise, in each of the pixel units 180, the output of a second driver 162 is connected to the gate of the first transistor 103 of the second pixel 100, the output of a third driver 163 is connected to the gate of the first transistor 103 of the third pixel 100, and the output of a fourth driver 164 is connected to the gate of the first transistor 103 of the fourth pixel 100.

With the above configuration, different distance sections can be measured using a plurality of pixels. It is therefore possible to increase the number of distance sections measurable in one cycle of “light exposure processing+readout processing.” In other words, the number of imaging distance sections (the number of distance sections to be measured) is represented by “(number of cycles)×(number of pixels 100 in pixel unit 180)×(number of memory elements in pixel 100).”

### Third Embodiment

In this embodiment, an example different in the configuration of the pixel from the first embodiment will be described.

The configuration of the distance measuring device of this embodiment is similar to that of the first embodiment. That is, as shown in FIG. 1, the distance measuring device includes the solid-state imaging device 1, the signal processing unit 2, the computing machine 3, and the light source 4. Detailed description of these components of the distance measuring device is omitted here.

—Configuration of Pixel—

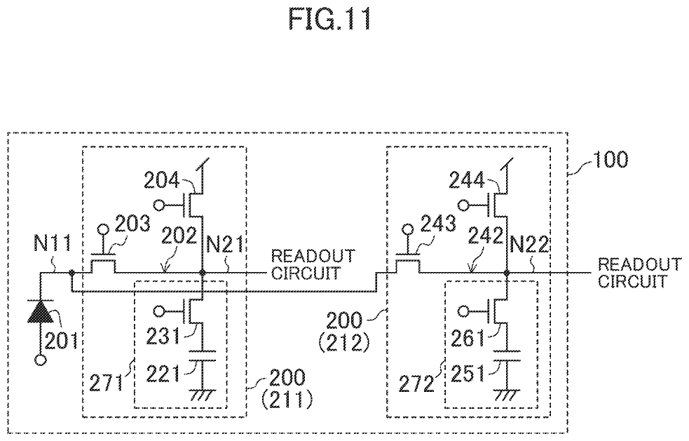

FIG. 11 shows a circuit diagram of a pixel 100 according to this embodiment. In this embodiment, the pixel 100 includes an avalanche photodiode 201 and a plurality of primary accumulation units 200. The plurality of primary accumulation units 200 are connected in parallel with respect to the cathode of the avalanche photodiode 201.

FIG. 11 shows an example of the pixel 100 having two primary accumulation units 200. For convenience of description, one of the primary accumulation units 200 is denoted by 211, and the other primary accumulation unit 200 is denoted by 212. The primary accumulation units 211 and 212 may also be collectively called the primary accumulation units 200 when they are described with no distinction between them.

The avalanche photodiode 201 photoelectrically converts incident light to generate a signal charge. Also, the avalanche photodiode 201 has a function of increasing the charge amount of the signal charge.

The primary accumulation unit 200 includes a primary accumulation region, a first transistor, at least one memory unit, and a third transistor.

In the example of FIG. 11, the primary accumulation unit 211 includes a primary accumulation region 202, a first transistor 203, a memory unit 271, and a third transistor 204. The primary accumulation unit 212 includes a primary accumulation region 242, a first transistor 243, a memory unit 272, and a third transistor 244.

The primary accumulation regions 202 and 242 temporarily hold the signal charge. In the example of FIG. 11, as the primary accumulation region 202, an example of temporarily holding the signal charge at a node N21 is shown. Also, as the primary accumulation region 242, an example of temporarily holding the signal charge at a node N22 is shown. The nodes N21 and N22 are individually connected to a readout circuit (e.g., a source follower circuit 600 to be described later).

The first transistor is provided between the avalanche photodiode and the primary accumulation region. As in the first embodiment, the first transistor has a function as a switch enabling/disabling transfer of the signal charge from the avalanche photodiode to the primary accumulation region.

More specifically, the first transistor 203 of the primary accumulation unit 211 is provided between the cathode of the avalanche photodiode 201 and the primary accumulation region 202. The first transistor 243 of the primary accumulation unit 212 is provided between the cathode of the avalanche photodiode 201 and the primary accumulation region 242. The gates of the first transistors 203 and 243 are individually connected to a bias circuit, for example. In the following description, the node connecting the avalanche photodiode 201 with the first transistors 203 and 243 is referred to as a node N11.

The memory unit 271 of the primary accumulation unit 211 includes at least one memory element 220 and at least one second transistor 230. In FIG. 11, the memory unit 271 includes one memory element 221 as the memory element 220. The second transistor 230 is connected between the memory element 221 and the node N21. For convenience of description, the second transistor 230 of the primary accumulation unit 211 is denoted by 231.

Likewise, the memory unit 272 of the primary accumulation unit 212 includes at least one memory element 250 and at least one second transistor 260. In FIG. 11, the memory unit 272 includes one memory element 251 as the memory element 250. The second transistor 260 is connected between the memory element 251 and the node N22. For convenience of description, the second transistor 260 of the primary accumulation unit 212 is denoted by 261.

The third transistor, connected to the primary accumulation region, has a function of discharging the signal charge in the primary accumulation region. When the third transistor is turned ON based on a control signal output from a bias circuit, allowing conduction between the power supply VD and the primary accumulation region, the signal charge in the primary accumulation region is discharged due to the action of the power supply VD.

More specifically, the third transistor 204 of the primary accumulation unit 211, connected to the primary accumulation region 202, has a function of discharging the signal charge in the primary accumulation region 202. Likewise, the third transistor 244 of the primary accumulation unit 212, connected to the primary accumulation region 242, has a function of discharging the signal charge in the primary accumulation region 242.

—Operation of Solid-State Imaging Device—

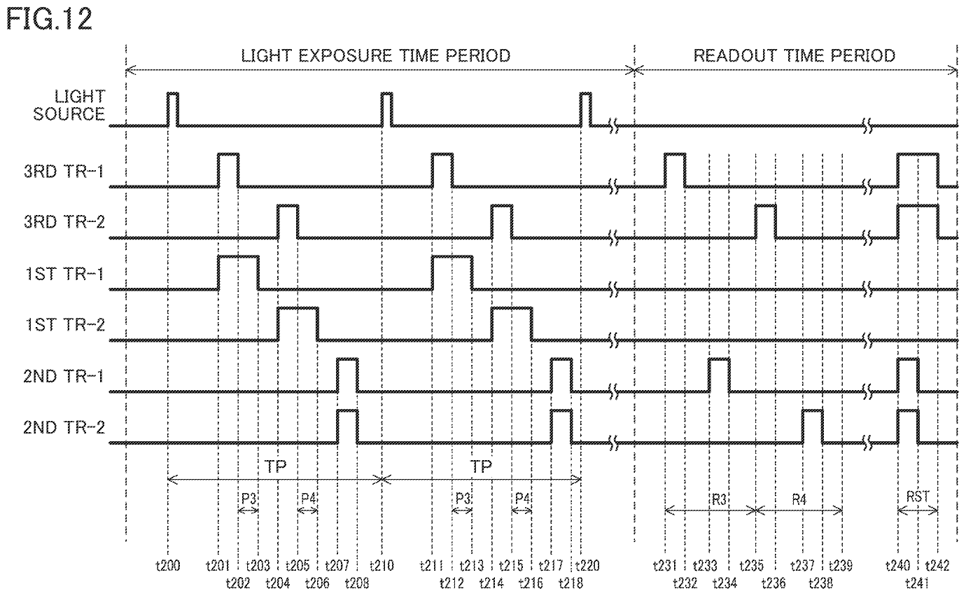

FIG. 12 shows an operation sequence of the pixel 100 during the time of light exposure processing and readout processing performed by the solid-state imaging device 1 of this embodiment. As shown in FIG. 12, in the solid-state imaging device 1, by turning ON/OFF the first transistors of the different primary accumulation units at timings corresponding to different distance sections, a plurality of times of light exposure are performed. After each time of light exposure, the second transistor corresponding to the light-exposed primary accumulation region is turned ON/OFF to accumulate the exposure result in the corresponding memory element. Thereafter, during the readout time period, the signal charges accumulated in the respective memory elements are read out to calculate the distance to the measuring target.

<Light Exposure Processing>

First, the operation of the solid-state imaging device 1 during the light exposure time period will be described with reference to FIG. 12. During the light exposure time period, assume that pulsed outgoing light is emitted from the light source 4 at a predetermined pulse period TP repeatedly (e.g., 1000 pulses). In FIG. 12, the time from t200 to t210 and the time from t210 to t220 are each one pulse period TP.

As described above, within one pulse period of the outgoing light, a plurality of times of light exposure are executed at timings corresponding to different distance sections. FIG. 12 shows an example in which two times of light exposure are performed within one pulse period TP and such two-time light exposure is repeated.

To state more specifically, at time t201, the third transistor 204 and the first transistor 203 of the primary accumulation unit 211 are turned ON simultaneously, to discharge the signal charges at the node N11 and the node N21. With this, the potential on the cathode side of the avalanche photodiode 201 is reset.

At time t202, at which the third transistor 204 is turned OFF, the first-time light exposure is started. Specifically, a signal charge generated by the avalanche photodiode 201 is input into the primary accumulation region 202 via the first transistor 203.

At time t203, at which the first transistor 203 is turned OFF, the first-time light exposure is completed, and the signal charge is temporarily held in the primary accumulation region 202. In the first-time light exposure, reflected light from a measuring target present in a first distance section D3 corresponding to the lapse time from time t200 at which the light source 4 emitted light until a time period P3 is input into the pixel 100 as incident light.

At time t204, before the second-time light exposure, the third transistor 244 and the first transistor 243 of the primary accumulation unit 212 are simultaneously turned ON, to reset the potential on the cathode side of the avalanche photodiode 201.

At time t205, at which the third transistor 244 is turned OFF, the second-time light exposure is started. Specifically, a signal charge generated by the avalanche photodiode 201 is input into the primary accumulation region 242 via the first transistor 243.

At time t206, at which the first transistor 243 is turned OFF, the second-time light exposure is completed, and the signal charge is temporarily held in the primary accumulation region 242. In the second-time light exposure, reflected light from a measuring target present in a second distance section D4 corresponding to the lapse time from time t200 at which the light source 4 emitted light until a time period P4 is input into the pixel 100 as incident light.

At time t207, after the first transistor 243 is turned OFF at time t206, the second transistors 231 and 261 of the primary accumulation units 211 and 212 are turned ON. With this, until time t208 at which the second transistors 231 and 261 are turned OFF, the first-time light exposure result is stored in the memory element 221 of the primary accumulation unit 211, and the second-time light exposure result is stored in the memory element 251 of the primary accumulation unit 212.

The operation in one pulse period TP described above as one set is repeated a predetermined number of times (e.g., 1000 pulses). In this way, the signal charges related to the measurement in the distance sections D3 and D4 are accumulated in the memory elements 221 and 251, respectively.

<Readout Processing>

When the light exposure processing by a predetermined number of pulses is finished, readout processing is then executed. The operation of the solid-state imaging device 1 during the readout time period will be described hereafter with reference to FIG. 12. First, during a first-time readout time period R3 (t231 to t235), readout processing for the first distance section D3 is executed.

Specifically, at time t231, the third transistor 204 of the primary accumulation unit 211 is turned ON, to discharge the signal charge in the primary accumulation region 202. With this, the primary accumulation region 202 is reset.

At time t232, the third transistor 204 is turned OFF, and when the second transistor 231 is turned ON at time t233, the signal charge accumulated in the memory element 221 corresponding to the first distance section D3 is read out to the primary accumulation region 202. The read signal charge is then read out to the subsequent readout circuit, and the distance to the measuring target present in the first distance section D3 is calculated in the signal processing unit 2.

At time t234, the second transistor 231 is turned OFF, and at time t235, the third transistor 244 of the primary accumulation unit 212 is turned ON, to reset the primary accumulation region 242.

At time t236, the third transistor 244 is turned OFF, and when the second transistor 261 is turned ON at time t237, the signal charge accumulated in the memory element 251 corresponding to the second distance section D4 is read out to the primary accumulation region 242. The read signal charge is then read out to the subsequent readout circuit, and the distance to the measuring target present in the second distance section D4 is calculated in the signal processing unit 2.

Once the readout processing for all the distance sections (the first and second distance sections D3 and D4 in this example) is finished, reset processing for the primary accumulation units 211 and 212 is executed. Specifically, the third transistor 204 and the second transistor 231 of the primary accumulation unit 211 are simultaneously turned ON, to discharge the signal charge accumulated in the memory element 221 (see time t240 to t241 in FIG. 12). Thereafter, the second transistor 231 is turned OFF, to discharge the charge remaining in the primary accumulation region 202. Likewise, the third transistor 244 and the second transistor 261 of the primary accumulation unit 212 are simultaneously turned ON, to discharge the signal charge accumulated in the memory element 251 (see time t240 to t241 in FIG. 12). Thereafter, the second transistor 261 is turned OFF, to discharge the charge remaining in the primary accumulation region 242.

As described above, in this embodiment, also, it is possible to increase the number of times of light exposure for each pulse period TP and, as a result, increase the number of times of multiplication. Since the light use efficiency can be determined by “light use efficiency=number of times of multiplication/number of times of light emission,” for example, the light use efficiency of the distance measuring device can be enhanced in comparison with the case of exposing light once for each pulse period TP.

Also, in this embodiment, since the primary accumulation region is not shared, the degree of freedom of setting of the ON period of the second transistors 231 and 261 (second transistors 230 and 260) enhances. To state specifically, in the first embodiment, the ON period of the second transistor 130 must be set within the time period from when the first transistor 103 is turned OFF until when the third transistor 104 is turned ON. In this embodiment, however, it is not necessarily required to set the ON period of the second transistor 130 within the time period from when the first transistor 103 is turned OFF until when the third transistor 104 is turned ON. This can enhance the distance resolution and increase the number of times of light exposure in one pulse period. Also, since the second transistors of the different primary accumulation units 200 can be turned ON simultaneously, the time of the light exposure processing can be shortened.

While FIG. 12 shows an example in which, in the readout time period, the primary accumulation unit 211 and the primary accumulation unit 212 perform readout at different timings, the operation may be made so that the signal charge accumulated in the memory element 221 of the primary accumulation unit 211 and the signal charge accumulated in the memory element 251 of the primary accumulation unit 212 be read out simultaneously.

—Alteration 1—

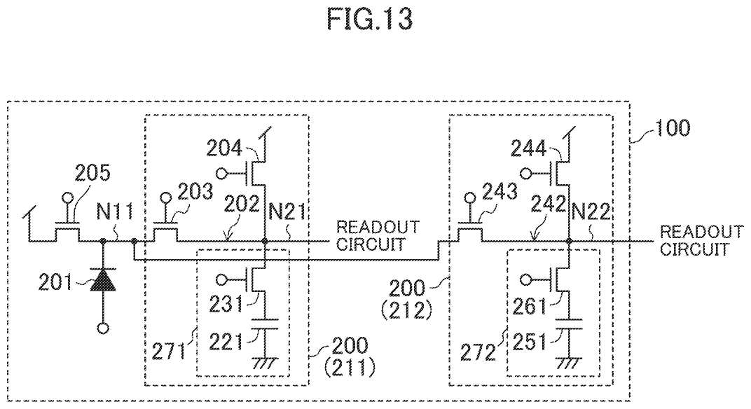

FIG. 13 shows a circuit diagram of a pixel according to Alteration 1 of the third embodiment.

This alteration is different from the third embodiment in having a fourth transistor 205 connected to the node N11, to which the cathode of the avalanche photodiode 201 is connected, to initialize the node N11 to a fixed potential. The node N11 is an example of the first node. The other configuration is similar to that of the third embodiment, and therefore detailed description thereof is omitted here.

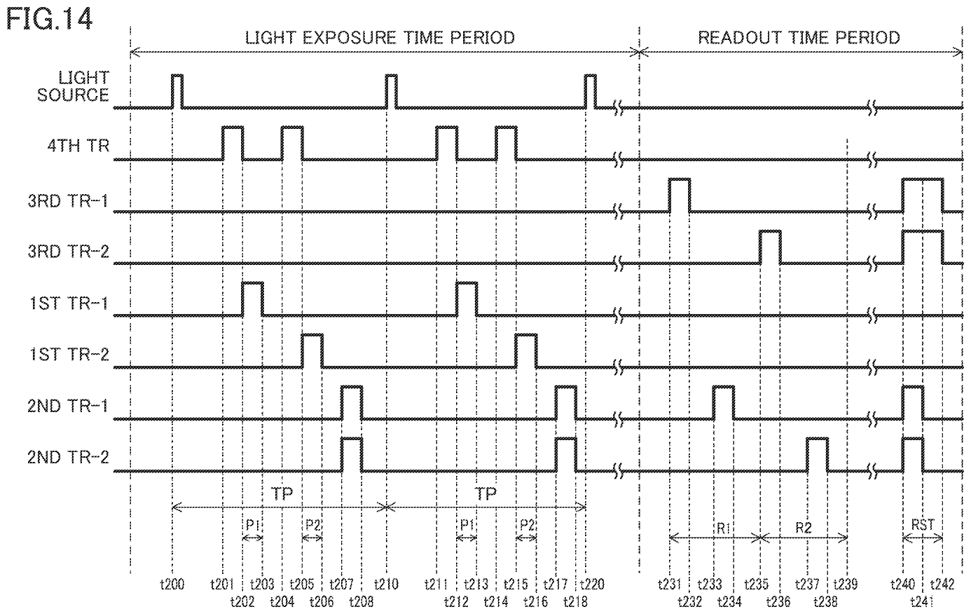

FIG. 14 shows an operation sequence of the pixel 100 during the time of light exposure processing and readout processing performed by the solid-state imaging device 1 of this alteration.

In the third embodiment described above, the cathode of the avalanche photodiode 201 is reset by turning ON the first transistor 203 and the third transistor 204, or the first transistor 243 and the third transistor 244, simultaneously. By contrast, in FIG. 14, the cathode of the avalanche photodiode 201 is reset by turning ON the fourth transistor 205 at time t201 until time t202. The other operation is similar to that in FIG. 12, and therefore detailed description thereof is omitted here.

Having the configuration described above, transistors required to perform high-speed ON/OFF operation can be centralized. More specifically, with the placement of the fourth transistor 205, the reset of the cathode of the avalanche photodiode 201 can be centralized in the fourth transistor 205. This eliminates the necessity for the first transistors 203 and 243 and the third transistors 204 and 244 to perform high-speed ON/OFF operation. A large-capacity capacitance element must be placed outside the pixel 100 to operate a transistor at high speed. By centralizing transistors required to perform high-speed ON/OFF operation, therefore, increase in chip area can be prevented or reduced. Also, since the ON resistance is small in comparison with the case of reset via two transistors, the discharge rate of charges, i.e., the reset rate can be made faster.

### Fourth Embodiment

In this embodiment, an example different in the configuration of the pixel 100 from the first embodiment will be described.

The configuration of the distance measuring device of this embodiment is similar to that of the first embodiment. That is, as shown in FIG. 1, the distance measuring device includes the solid-state imaging device 1, the signal processing unit 2, the computing machine 3, and the light source 4. Detailed description of these components of the distance measuring device is omitted here.

—Configuration of Pixel—

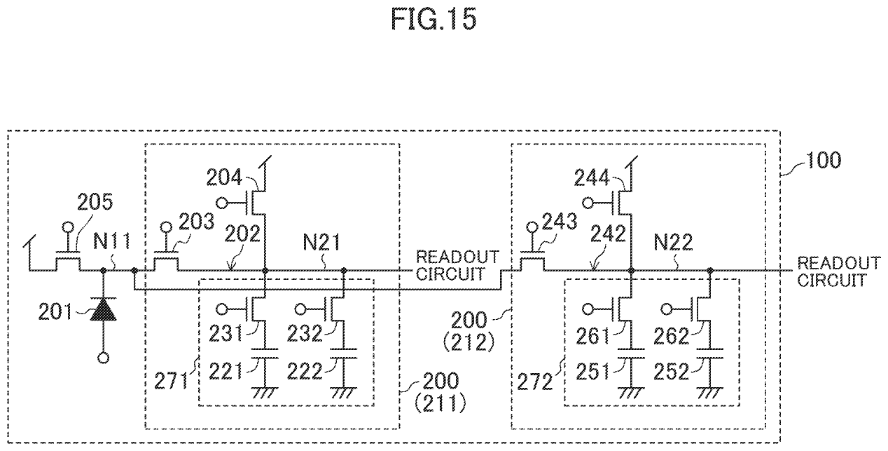

FIG. 15 shows a circuit diagram of a pixel 100 according to this embodiment. In this embodiment, the pixel 100 includes an avalanche photodiode 201 and a plurality of primary accumulation units 200. The plurality of primary accumulation units 200 are connected in parallel with respect to the cathode of the avalanche photodiode 201. In FIG. 15, components in common with FIG. 11 are denoted by the same reference characters, and description will be made here centering differences from FIG. 11.

In FIG. 15, the configurations of memory units 271 and 272 are different from those in FIG. 11.

Specifically, in FIG. 15, the memory unit 271 includes two memory elements 221 and 222 and two second transistors 231 and 232. More specifically, a serial circuit of the second transistor 231 and the memory element 221 and a serial circuit of the second transistor 232 and the memory element 222 are connected in parallel between a node N21 and the ground. Note that the number of the memory elements and the number of the second transistors in the memory unit 271 are not limited to two, but may be three or more.

Likewise, the memory unit 272 includes two memory elements 251 and 252 and two second transistors 261 and 262. More specifically, a serial circuit of the second transistor 261 and the memory element 251 and a serial circuit of the second transistor 262 and the memory element 252 are connected in parallel between a node N22 and the ground. Note that the number of the memory elements and the number of the second transistors in the memory unit 272 are not limited to two, but may be three or more.

—Operation of Solid-State Imaging Device—

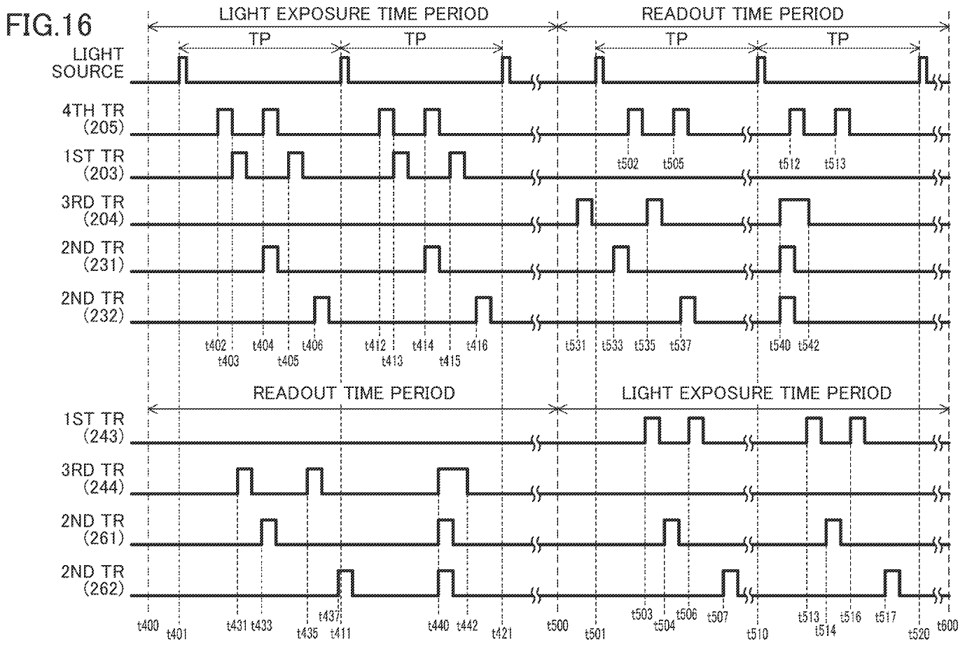

FIG. 16 shows an operation sequence of the pixel 100 during the time of light exposure processing and readout processing performed by the solid-state imaging device 1 of this embodiment. As shown in FIG. 16, in the solid-state imaging device 1, by turning ON/OFF a first transistor 203 at timings corresponding to different distance sections, a plurality of times of light exposure is performed. Likewise, by turning ON/OFF a first transistor 243 at timings corresponding to different distance sections, a plurality of times of light exposure is performed. Moreover, in this embodiment, by turning ON/OFF the first transistors 203 and 243 of different primary accumulation units 211 and 212 at different timings, a plurality of times of light exposure can be performed. During the readout time period, the signal charges stored in the respective memory elements are read out to calculate the distances to measuring targets.

In this embodiment, while the light exposure processing is underway in the primary accumulation unit 211, the readout processing is performed in the other primary accumulation unit 212. Also, while the readout processing is underway in the primary accumulation unit 211, the light exposure processing is performed in the other primary accumulation unit 212. That is, parallel processing of performing the light exposure processing and the readout processing alternately is executed in the primary accumulation unit 211 and the primary accumulation unit 212.

Specifically, in the example of FIG. 16, during the time period from t400 to t500, the light exposure processing in the primary accumulation unit 211 and the readout processing in the primary accumulation unit 212 are performed. Also, during the time period from t500 to t600, the readout processing in the primary accumulation unit 211 and the light exposure processing in the primary accumulation unit 212 are performed.

<Light Exposure Processing in Primary Accumulation Unit 211>

In the primary accumulation unit 211, after the light source 4 emitted light at time t401, a fourth transistor 205 is turned ON at time t402 to discharge a signal charge at a node N11. With this, the potential on the cathode side of the avalanche photodiode 201 is reset.

At time t403, at which the fourth transistor 204 is turned OFF and the first transistor 203 is turned ON, the first-time light exposure is started. Specifically, a signal charge generated by the avalanche photodiode 201 is input into a primary accumulation region 202 (node N21) via the first transistor 203.

When the first transistor 203 is turned OFF, the first-time light exposure is completed, and the signal charge is temporarily held in the primary accumulation region 202. In the first-time light exposure, reflected light from a measuring target present in a first distance section D5 corresponding to the lapse time from time t401 at which the light source 4 emitted light until time t403 is input into the pixel 100 as incident light.

At time t404, after the first transistor 203 is turned OFF, both the second transistor 231 and the fourth transistor 205 are turned ON. With the second transistor 231 being ON, the signal charge held in the primary accumulation region 202, i.e., the result of the first-time light exposure is accumulated in the memory element 221. Also, with the fourth transistor 205 being ON, the potential on the cathode side of the avalanche photodiode 201 is reset. In this way, by providing the fourth transistor 205, it is possible to accumulate a signal charge in the memory element 221 even during the reset time of the potential on the cathode side of the avalanche photodiode 201.

At time t405, after the second transistor 231 and the fourth transistor 205 are turned OFF, the first transistor 203 is turned ON again to start the second-time light exposure. In the second-time light exposure, also, a signal charge generated by the avalanche photodiode 201 is input into the primary accumulation region 202 (node N21) via the first transistor 203.

At time t406, after the first transistor 203 is turned OFF, the second transistor 232 different from one in the first-time light exposure is turned ON. With this, the signal charge held in the primary accumulation region 202, i.e., the result of the second-time light exposure is accumulated in the memory element 222.

As a result, the result of the first-time light exposure is stored in the first memory element 221 and the result of the second-time light exposure is stored in the second memory element 222.

<Readout Processing in Primary Accumulation Unit 212>

As described above, in the primary accumulation unit 212, readout processing of reading data accumulated in the light exposure processing before time t400 is executed during the time period from t400 to t500. Specifically, the following processing is executed during the readout time period from t400 to t500. Note that, during the readout time period, the first transistor 243 of the primary accumulation unit 212 is OFF, and therefore the primary accumulation unit 212 is not affected by the light exposure processing in the primary accumulation unit 211.

Specifically, at time t431, a third transistor 244 is turned ON to reset a primary accumulation region 242.

After the third transistor 244 is turned OFF, when the second transistor 261 is turned ON at time t433, the signal charge accumulated in the memory element 251 is read out to the primary accumulation region 242. The read signal charge is then read out to the subsequent readout circuit, and the distance to the measuring target is calculated by the computing machine 3.

After the second transistor 261 is turned OFF, when the second transistor 262 is turned ON at time t437, the signal charge accumulated in the memory element 252 is read out to the primary accumulation region 242. The read signal charge is then read out to the subsequent readout circuit, and the distance to the measuring target is calculated by the computing machine 3.

Thereafter, as described above, during the time period from t500 to t600, readout processing of reading data accumulated in the above-described light exposure processing is executed in the primary accumulation unit 211. Also, in the primary accumulation unit 212, the next light exposure processing is executed. Such readout processing and light exposure processing are substantially the same except that the operating units are the opposite of the above case, and therefore detailed description is omitted here.

As described above, in this embodiment, also, it is possible to increase the number of times of light exposure for each pulse period TP and, as a result, increase the number of times of multiplication. Since the light use efficiency can be determined by “light use efficiency=number of times of multiplication/number of times of light emission,” for example, the light use efficiency of the distance measuring device can be enhanced in comparison with the case of exposing light once for each pulse period TP.

Also, since a plurality of primary accumulation units 210, such as 211 and 212, are provided to execute the light exposure processing and the readout processing alternately, the light exposure processing can be performed continuously by emitting light constantly from the light source 4, and in parallel with the light exposure processing, the readout processing can be executed. This can enhance the utilization rate of the light source 4, and therefore further enhance the light use efficiency of the distance measuring device when viewed over the entire operation time period.

—Alteration 1—

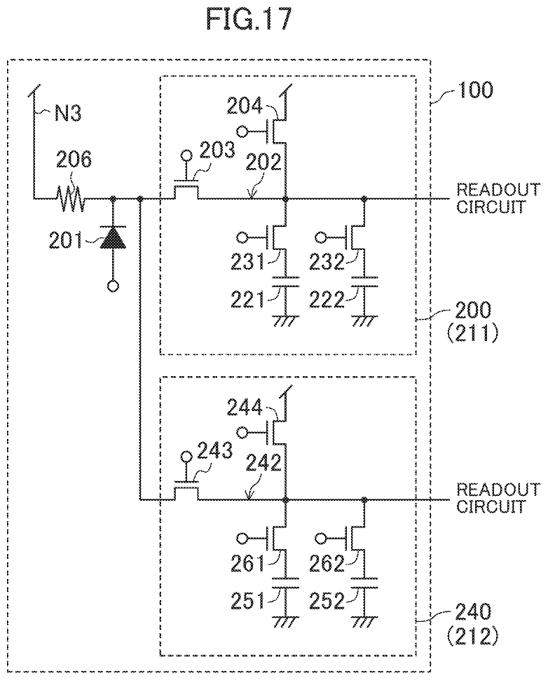

FIG. 17 is a circuit diagram of a pixel according to Alteration 1 of the fourth embodiment.

In FIG. 17, a quenching resistance 206 is provided between the cathode of the avalanche photodiode 201 and a first potential line N3 of a fixed potential, in place of the fourth transistor 205 in FIG. 16. The other configuration is similar to that of FIG. 16.

The quenching resistance 206, serving as a quenching element for avalanche multiplication, has a function of initializing the cathode of the avalanche photodiode 201 to a fixed potential. And, by adjusting the gate voltages of the first transistors 203 and 243 in the light exposure time period, multiplied charges can be held in the primary accumulation regions 202 and 242.

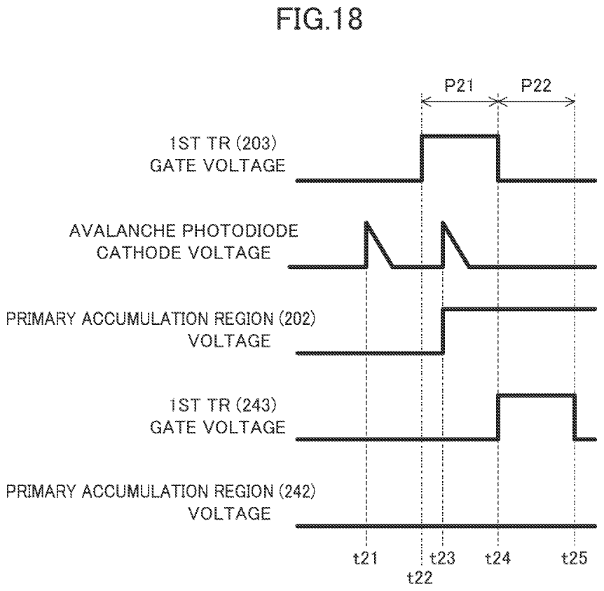

With the above configuration, at the time of multiplication performed by the avalanche photodiode 201, charges spontaneously flow via the quenching resistance 206 to resume the original potential (see near time t21 and t23 in FIG. 18). FIG. 18 shows an example in which avalanche multiplication is performed in a light exposure time period P21 and is not performed in a light exposure time period P22.

The resistance value of the quenching resistance 206 is not especially limited, but is preferably set at a value with which the original voltage is resumed within the ongoing light exposure time period when avalanche multiplication is performed.

Thus, as shown in FIG. 18, for example, the light exposure result (multiplied result by the avalanche photodiode 201) in the light exposure time period P21 is held in the primary accumulation region 202, and thereafter, without resetting, light exposure in the light exposure time period P22 can be executed. In other words, in the example of FIG. 18, even when avalanche multiplication is performed in the first-time light exposure, spontaneous reset is performed before start of the second-time light exposure time period P22.

As described above, in this alteration, since it is unnecessary to provide a reset time of the avalanche photodiode 201 between the adjacent light exposure time periods P21 and P22, light exposure for continuous distance sections within the same pulse period is possible.

In place of the quenching resistance 206, any other element serving as a quenching element for avalanche multiplication may be used. For example, a transistor may be provided in place of the quenching resistance 206, and the ON resistance of the transistor may be adjusted to serve as a quenching element.

—Alteration 2—

FIG. 19 is a circuit diagram of a pixel according to Alteration 2 of the fourth embodiment.

This alteration describes a configuration example in which a plurality of primary accumulation units 200 are connected to a single source follower 600. Specifically, in Alteration 2, a fifth transistor is provided between each of the primary accumulation units 200 and the gate of an input transistor 601 of the source follower 600.

In the example of FIG. 19, a fifth transistor 207 is provided between the primary accumulation region 202 of the primary accumulation unit 211 and the gate of the input transistor 601, and a fifth transistor 247 is provided between the primary accumulation region 242 of the primary accumulation unit 212 and the gate of the input transistor 601.

With the above configuration, the source follower 600 can be shared.

Also, as described above with reference to FIG. 16, while the light exposure processing is being executed in the primary accumulation unit 211, the readout processing can be executed in the other primary accumulation unit 212.

To summarize the above description, the distance measuring device of the present disclosure includes: the light source 4 as the light emitting unit that emits outgoing light toward a measuring target; the pixel array 11 having a plurality of pixels 100 arranged in a matrix; and the control unit that calculates the distance to the measuring target. The pixel array 11 receives reflected light of the outgoing light reflected from the measuring target as incident light.

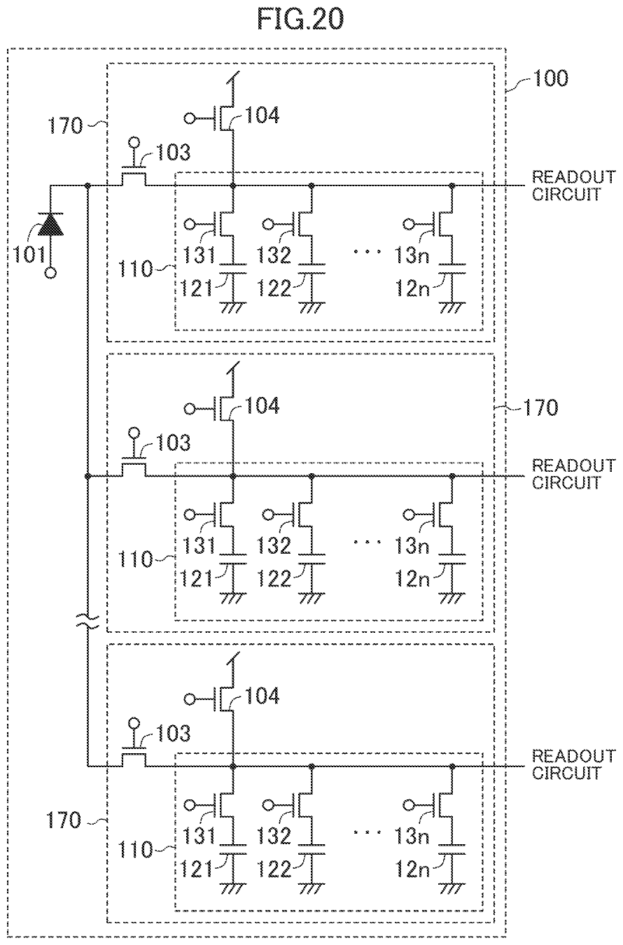

Each pixel 100 includes the avalanche photodiode 101 and at least one primary accumulation unit 170 (see FIG. 20).

The primary accumulation unit 170 includes the primary accumulation region 102, the first transistor 103, the memory unit 110, and the third transistor 104. When a plurality of primary accumulation units 170 are provided, they are connected in parallel with respect to the cathode of the avalanche photodiode 101.

The avalanche photodiode 101 photoelectrically converts incident light to generate a signal charge. The primary accumulation region 102, connected to the cathode of the avalanche photodiode 101 via the first transistor 103, has a function of temporarily holding the signal charge generated by the avalanche photodiode 101. The third transistor 104, connected to the primary accumulation region 102, has a function of discharging the signal charge in the primary accumulation region 102.

The memory unit 110 has at least one memory element 120. The memory element 120 is connected to the primary accumulation region 102 via the second transistor 130. When a plurality of memory elements 120 are provided, the memory elements 120 are connected to the primary accumulation region 102 via the respective second transistors 130. That is, the plurality of memory elements 120 are connected in parallel with respect to the primary accumulation region 102.

FIG. 20 shows an example in which the pixel 100 is constituted by m (m is an arbitrary integer) primary accumulation units 170. Also, each primary accumulation unit 170 has n (n is an arbitrary integer) memory elements 120. That is, the pixel 100 of FIG. 20 includes m×n memory elements 120. Also, in the pixel 100 of FIG. 20, the numbers of primary accumulation regions 102, first transistors 103, and third transistors 104 are each m.

With the above configuration, as described above, the number of times of light exposure for each pulse period TP can be increased, and as a result, the number of times of multiplication can be increased. This can enhance the light use efficiency of the distance measuring device in comparison with the case of exposing light once for each pulse period TP.

The embodiments have been described hereinbefore for illustration of the technologies according to the present disclosure, and the accompanying drawings and the detailed description have been presented for this purpose.

Therefore, in the accompanying drawings and the detailed description, not only components essential for solution of the prior art problems but also components that are not essential for such solution may be included for the illustration of the disclosed technologies. Such non-essential components should not be recognized as being essential simply because such components are shown in the accompanying drawings and described in the detailed description.

Also, since the embodiments described above are presented only for illustration of the technologies according to the present disclosure, various changes, replacements, additions, and omissions can be made within the scope of the appended claims or equivalence thereof. It is also possible to use the configurations of the different embodiments and alterations in appropriate combination.

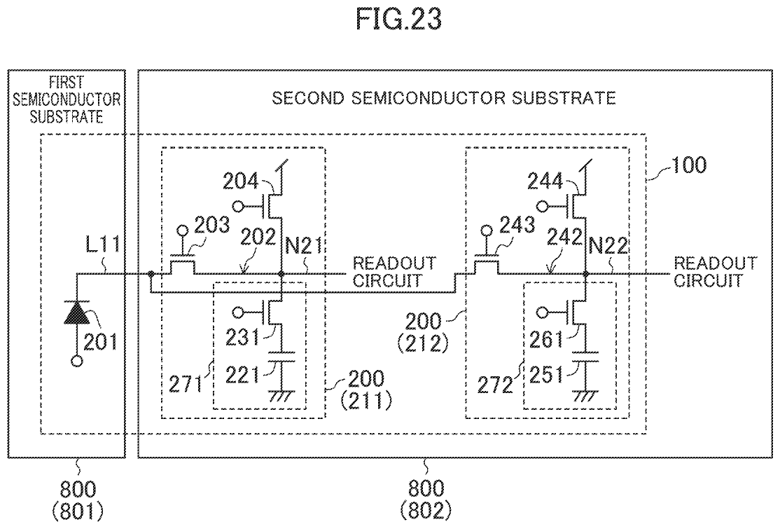

For example, in the embodiments and alterations described above, the solid-state imaging device 1 may have a plurality of semiconductor substrates 800. FIG. 23 shows an example in which the pixel 100 shown in FIG. 11 is mounted on two semiconductor substrates 800 dividedly.

More specifically, in FIG. 23, the solid-state imaging device 1 includes a first semiconductor substrate 801 and a second semiconductor substrate 802 as the plurality of semiconductor substrates 800. The avalanche photodiode 201 is placed on the first semiconductor substrate 801, and the primary accumulation units 200 (211 and 212) are placed on the second semiconductor substrate 802.

In the example of FIG. 23, the avalanche photodiode 201 is placed on the semiconductor substrate different from one on which the primary accumulation regions 202 and 242, the first transistors 203 and 243, the memory elements 221 and 251, the second transistors 231 and 261, and the third transistors 204 and 245 are placed. The avalanche photodiode 201 is connected to the first transistors 203 and 243 via a line L11.

With the above configuration, increase in pixel size with increase in the number of memory elements and transistors can be prevented or reduced.

The configuration of FIG. 23 is not limited to the pixel of FIG. 11, but is also applicable to the pixels 100 shown in figures other than FIG. 11. That is, although not illustrated, in any of the pixels 100 shown in other figures, the avalanche photodiode may be placed in a semiconductor substrate different from one on which the primary accumulation region, the first transistor, the memory element, the second transistor, and the third transistor are placed, and the avalanche photodiode and the first transistor may be connected via a line.

The present disclosure is significantly useful because the distance measuring device of this disclosure can enhance the light use efficiency.

What is claimed is:

1. A distance measuring device, comprising:
a light emitting unit emitting outgoing light toward a measuring target;
a pixel array including a plurality of pixels arranged in a matrix and receiving reflected light of the outgoing light reflected from the measuring target as incident light; and
a control unit controlling the light emitting unit and the pixel array and calculating a distance to the measuring target,
wherein
each of the plurality of pixels includes
an avalanche photodiode photoelectrically converting the incident light to generate a signal charge,
a primary accumulation region temporarily holding the signal charge; and
a plurality of memory elements provided in parallel with respect to the primary accumulation region for accumulating the signal charge, and
the control unit controls the light emitting unit to emit the outgoing light as pulses of a predetermined period, performs a plurality of times of light exposure at timings corresponding to different distance sections within one pulse period of the outgoing light, allows signal charges generated after the respective times of light exposure to be accumulated in the different memory elements, and reads out the signal charges to calculate the distance to the measuring target.

2. The distance measuring device of claim 1, comprising
a first transistor provided between a cathode of the avalanche photodiode and the primary accumulation region for enabling/disabling transfer of the signal charge to the primary accumulation region.

3. The distance measuring device of claim 2, comprising
a plurality of second transistors provided between the primary accumulation region and the respective memory elements for enabling/disabling transfer of the signal charge to the memory elements.

4. The distance measuring device of claim 3, comprising
a third transistor connected to the primary accumulation region for discharging the signal charge in the primary accumulation region.

5. The distance measuring device of claim 4, wherein
a plurality of primary accumulation units, each including the primary accumulation region, the first transistor, the plurality of memory elements, the plurality of second transistors, and the third transistor, are provided, and
the plurality of primary accumulation units are connected in parallel with respect to the cathode of the avalanche photodiode.

6. The distance measuring device of claim 3, comprising
a first driver circuit including the number of first bias circuits corresponding with the number of the memory elements,
wherein
each of the first bias circuits includes a first switching element, a second switching element, a first capacitance connected to a gate of the first transistor via the first switching element, and a second capacitance connected to the gate of the first transistor via the second switching element.

7. The distance measuring device of claim 4, comprising
a second driver circuit including the number of second bias circuits corresponding with the number of the memory elements,
wherein
each of the second bias circuits includes a third switching element, a fourth switching element, a third capacitance connected to a gate of the third transistor via the third switching element, and a fourth capacitance connected to the gate of the third transistor via the fourth switching element.

8. The distance measuring device of claim 2, comprising
a fourth transistor connected to a first node that connects the cathode of the avalanche photodiode and the first transistor, to initialize the first node to a fixed potential.

9. The distance measuring device of claim 8, comprising
a third driver circuit including the number of third bias circuits corresponding with the number of the memory elements,
wherein
each of the third bias circuits includes a fifth switching element, a sixth switching element, a fifth capacitance connected to a gate of the fourth transistor via the fifth switching element, and a sixth capacitance connected to the gate of the fourth transistor via the sixth switching element.

10. The distance measuring device of claim 1, comprising
a quenching resistance provided between a cathode of the avalanche photodiode and a first potential line of a fixed potential.

11. The distance measuring device of claim 1, wherein
the plurality of memory elements include at least one first memory element smaller in memory capacity than the primary accumulation region.

12. A distance measuring device, comprising:
a light emitting unit emitting outgoing light toward a measuring target;
a pixel array including a plurality of pixels arranged in a matrix and receiving reflected light from the measuring target; and
a control unit controlling the light emitting unit and the pixel array and calculating a distance to the measuring target,
wherein
each of the plurality of pixels includes
an avalanche photodiode photoelectrically converting received light to generate a signal charge, and
a plurality of primary accumulation units temporarily holding the signal charge,
each of the plurality of primary accumulation units includes
a primary accumulation region temporarily holding the signal charge, and
a memory element for accumulating the signal charge in the primary accumulation region, and
the control unit controls the light emitting unit to emit the outgoing light as pulses of a predetermined period, performs a plurality of times of light exposure at timings corresponding to different distance sections within one pulse period of the outgoing light, allows signal charges generated after the respective times of light exposure to be accumulated in the different memory elements, and reads out the signal charges to calculate the distance to the measuring target.

13. The distance measuring device of claim 12, wherein
each of the primary accumulation units includes a first transistor provided between a cathode of the avalanche photodiode and the primary accumulation region for enabling/disabling transfer of the signal charge to the primary accumulation region.

14. The distance measuring device of claim 13, wherein
each of the primary accumulation units includes a second transistor provided between the primary accumulation region and the memory element for enabling/disabling transfer of the signal charge to the memory element.

15. The distance measuring device of claim 14, wherein
each of the primary accumulation units includes a third transistor connected to the primary accumulation region for discharging the signal charge in the primary accumulation region.

16. The distance measuring device of claim 14, wherein
a plurality of memory units each including the memory element and the second transistor are provided, and
the plurality of memory units are connected in parallel with respect to the primary accumulation region.

17. The distance measuring device of claim 12, comprising
a fourth transistor provided between a first signal line, connecting a cathode of the avalanche photodiode and the plurality of primary accumulation units, and a first potential line of a fixed potential, to initialize the first signal line to a fixed potential.

18. The distance measuring device of claim 12, comprising
a quenching resistance provided between a first signal line, connecting a cathode of the avalanche photodiode and the plurality of primary accumulation units, and a first potential line of a fixed potential.

19. The distance measuring device of claim 12, comprising
a source follower circuit for reading out the signal charges stored in the memory elements,
wherein
each of the primary accumulation units includes a fifth transistor provided between the source follower circuit and the primary accumulation region.

20. The distance measuring device of claim 13, wherein
the plurality of pixels are grouped into units each including a predetermined number of pixels,
such units are arranged in a matrix in the pixel array, and
in each of the units, gates of the first transistors of the different pixels are connected to different driver circuits.

21. A solid-state imaging device, comprising
a pixel array including a plurality of pixels arranged in a matrix and receiving incident light,
wherein
each of the plurality of pixels includes
an avalanche photodiode photoelectrically converting the incident light to generate a signal charge,
a primary accumulation region for temporarily holding the signal charge;
a first transistor provided between a cathode of the avalanche photodiode and the primary accumulation region for enabling/disabling transfer of the signal charge to the primary accumulation region; and
a plurality of memory elements provided in parallel with respect to the primary accumulation region for accumulating the signal charge, and
the first transistor is turned ON/OFF by receiving gate voltages supplied from different bias supply elements of a driver circuit at different timings within one period, to perform a plurality of times of light exposure, and resultant signal charges are accumulated in the different memory elements.

22. The solid-state imaging device of claim 21, comprising:
a plurality of second transistors provided between the primary accumulation region and the respective memory elements for enabling/disabling transfer of the signal charge to the memory elements; and
a third transistor connected to the primary accumulation region for discharging the signal charge in the primary accumulation region.

23. The solid-state imaging device of claim 22, wherein
a plurality of primary accumulation units, each including the primary accumulation region, the first transistor, the plurality of memory elements, the plurality of second transistors, and the third transistor, are provided, and
the plurality of primary accumulation units are connected in parallel with respect to the cathode of the avalanche photodiode.

24. The solid-state imaging device of claim 21, comprising:
a first driver circuit including the number of first bias circuits corresponding with the number of the memory elements,
wherein
each of the first bias circuits includes a first switching element, a second switching element, a first capacitance connected to a gate of the first transistor via the first switching element, and a second capacitance connected to the gate of the first transistor via the second switching element.

25. The solid-state imaging device of claim 22, comprising:
a second driver circuit including the number of second bias circuits corresponding with the number of the memory elements,
wherein
each of the second bias circuits includes a third switching element, a fourth switching element, a third capacitance connected to a gate of the third transistor via the third switching element, and a fourth capacitance connected to the gate of the third transistor via the fourth switching element.

26. The solid-state imaging device of claim 21, comprising
a fourth transistor connected to a first node that connects the cathode of the avalanche photodiode and the first transistor, to initialize the first node to a fixed potential.

27. The solid-state imaging device of claim 26, comprising
a third driver circuit including the number of third bias circuits corresponding with the number of the memory elements,
wherein
each of the third bias circuits includes a fifth switching element, a sixth switching element, a fifth capacitance connected to a gate of the fourth transistor via the fifth switching element, and a sixth capacitance connected to the gate of the fourth transistor via the sixth switching element.

28. The solid-state imaging device of claim 21, comprising
a quenching resistance provided between the cathode of the avalanche photodiode and a first potential line of a fixed potential.

29. The solid-state imaging device of claim 21, wherein
the plurality of memory elements include at least one first memory element smaller in memory capacity than the primary accumulation region.

30. The solid-state imaging device of claim 23, comprising
a source follower circuit for reading out the signal charges stored in the memory elements,
wherein
each of the primary accumulation units includes a fifth transistor provided between the source follower circuit and the primary accumulation region.

31. The solid-state imaging device of claim 21, wherein
the plurality of pixels are grouped into units each including a predetermined number of pixels,
such units are arranged in a matrix in the pixel array, and
in each of the units, gates of the first transistors of the different pixels are connected to different driver circuits.

32. The solid-state imaging device of claim 22, comprising
a fourth driver circuit including the number of fourth bias circuits corresponding with the memory elements,
wherein
each of the fourth bias circuits includes a seventh switching element, an eighth switching element, a seventh capacitance connected to a gate of the second transistor via the seventh switching element, and an eighth capacitance connected to the gate of the second transistor via the eighth switching element.

33. The solid-state imaging device of claim 22, comprising a plurality of semiconductor substrates,
wherein
the avalanche photodiode is placed on a semiconductor substrate different from one on which the primary accumulation region, the first transistor, the memory elements, the second transistors, and the third transistor are placed, and
the avalanche photodiode and the first transistor are connected via a line.
